(19) United States
(12) Patent Application Publication
(10) Pub. No.: US 2023/0018120 A1
(43) Pub. Date: Jan. 19, 2023

(54) REGULATION OF ON-SITE ELECTROCHEMICAL GENERATION OF HYDROGEN PEROXIDE FOR ULTRAVIOLET ADVANCED OXIDATION PROCESS CONTROL

(71) Applicant: Evoqua Water Technologies LLC, Pittsburgh, PA (US)

(72) Inventors: JOSHUA GRIFFIS, Ashburnham, MA (US); BENJAMIN SATTERFIELD, Ayer, MA (US); SIMON DUKES, Chelmsford, MA (US); GEORGE GU, Andover, MA (US); YANG CHEN, Lowell, MA (US)

(73) Assignee: Evoqua Water Technologies LLC, Pittsburgh, PA (US)

(21) Appl. No.: 17/632,431

(22) PCT Filed: Jul. 31, 2020
(86) PCT No.: PCT/US20/44476

§ 371 Date: Feb. 2, 2022

Related U.S. Application Data
(60) Provisional application No. 62/882,244, filed on Aug. 2, 2019.
(60) Provisional application No. 63/058,528, filed on Jul. 30, 2020.

(51) Int. Cl. C02F 1/467; C02F 1/32; C25B 1/30; C25B 15/02

(52) U.S. Cl. CPC C02F 1/4672; C02F 1/325; C25B 1/30; C25B 15/02; C02F 2101/30

(57) ABSTRACT

A water treatment system comprises an actinic radiation reactor, an electrochemical cell configured to produce hydrogen peroxide and having an outlet in fluid communication between a source of electrolyte and the actinic radiation reactor, and a source of oxygen in communication with an inlet of the electrochemical cell.

### BACKGROUND

### 1. Field of Invention

Aspects and embodiments disclosed herein are generally directed to advanced oxidation systems including in-situ electrochemical hydrogen peroxide generators and to methods of operating or constructing same.

### 2. Discussion of Related Art

Within the last years many research works showed a suitability of Advanced Oxidation Processes (AOPs) for many applications, especially for water treatment (Legrini, O., Oliveros, E., Braun, A. M. (1993). Photochemical Processes for Water Treatment. Chm. Rev. 1093,93,671-698; Bolton et al. (1996). Figures of Merit for the technical development and application of Advanced Oxidation Processes. J. of Advanced Oxidation Technologies, 1,113-17).

Advanced Oxidation Processes (AOPs) for water treatment utilize highly reactive radical species, for example, hydroxyl radicals (.OH), for oxidation of toxic or non or less biodegradable hazardous water contaminants, for example, industrial contaminants.

Due to the high oxidation potential and low selectivity of the hydroxyl radicals, therefore reacting with almost every organic compound, the AOP can be used to eliminate the contaminants, i.e., residuals of pesticides, industrial solvents, PFAS, pharmaceuticals, hormones, drugs, personal care products or x-ray contrast media, from (contaminated) water.

The versatility of an AOP is also enhanced by the fact that they offer different possible ways for the production of hydroxyl radicals, thus allowing a better compliance with specific treatment requirements.

Malato et al. (2002). Photocatalysis with solar energy at a pilot-plant scale: an overview. Applied Catalysis B: Environmental 37 1-15 review a use of sunlight to produce hydroxyl radicals.

In an ultraviolet driven AOP (UV AOP) UV radiation is used to generate the hydroxyl radicals by photolysis. Traditional UV driven AOPs for water treatment can be referred to as UV/H₂O₂ since H₂O₂ is being photolyzed by UV radiation to produce hydroxyl radicals.

Existing AOPs use expensive reactants/oxidants, for example, H₂O₂, as well as a high energy demand needed for radical production, for example, a high UV irradiation energy for radical production by an UV AOP. A significant number of radicals are not consumed by oxidation of the contaminants but by side reactions with organic background of a water matrix, e.g., humins, humic acid, or citric acid.

### SUMMARY

In accordance with an aspect of the present invention, there is provided a water treatment system. The system comprises an actinic radiation reactor, an electrochemical cell configured to produce hydrogen peroxide and having an outlet in fluid communication between a source of electrolyte and the actinic radiation reactor, and a source of oxygen in communication with an inlet of the electrochemical cell. In some embodiments, the system further comprises a first conduit fluidically coupling the source of electrolyte to the inlet of the electrochemical cell and a second conduit fluidically coupling the outlet of the electrochemical cell to an inlet of the actinic radiation reactor.

In some embodiments, the outlet of the electrochemical cell is fluidically coupled to a point of introduction in a conduit fluidically coupling the source of electrolyte to an inlet of the electrochemical cell.

In some embodiments, the actinic radiation reactor is an ultraviolet advanced oxidation process reactor.

In some embodiments, the electrolyte comprises water.

In some embodiments, the system further comprises a storage tank coupled to the outlet of the electrochemical cell.

In some embodiments, the system further comprises a conduit fluidically coupled to an outlet of the actinic radiation reactor and a second electrochemical cell having an outlet in fluid communication with the conduit downstream of the outlet of the actinic radiation reactor. The second electrochemical cell may be configured to produce a chemical agent that quenches hydrogen peroxide present in a treated aqueous solution in the conduit.

In some embodiments, the system further comprises a storage tank coupled to the outlet of the second electrochemical cell.

In some embodiments, the chemical agent includes sodium hypochlorite.

In some embodiments, the conduit fluidically couples the outlet of the actinic radiation reactor to an inlet of the second electrochemical cell.

In some embodiments, the outlet of the second electrochemical cell is fluidically coupled to a point of introduction in the conduit downstream of the outlet of the actinic radiation reactor.

In some embodiments, the system further comprises a sensor configured to measure a concentration of one or more contaminants in an aqueous solution, the sensor positioned one of upstream of the actinic radiation reactor or downstream of the actinic radiation reactor.

In some embodiments, the system further comprises a controller in communication with the sensor and configured to adjust one or more operating parameters of the system responsive to a measured concentration of the one or more contaminants.

In some embodiments, the one or more operating parameters including one of power applied to the electrochemical cell, power applied to the second electrochemical cell, power applied to the actinic radiation reactor, and flow rate of electrolyte or aqueous solution through one of the electrochemical cell, the second electrochemical cell, or the actinic radiation reactor.

In some embodiments, the source of oxygen is configured to introduce the oxygen into the electrolyte upstream of the electrochemical cell.

In some embodiments, the controller is further configured to regulate a rate of introduction of the oxygen into the electrolyte responsive to the measured concentration of the one or more contaminants.

In some embodiments, the system further comprises a controller configured to adjust a flow rate of hydrogen peroxide from the storage tank into the actinic radiation reactor based on one or more measured characteristics of electrolyte from the source of electrolyte or one or more measured characteristics of a treated aqueous solution generated in the actinic radiation reactor.

In some embodiments, the system further comprises a controller configured to adjust a flow rate of sodium hypochlorite from the storage tank into the conduit downstream of the outlet of the actinic radiation reactor based on one or more measured characteristics of electrolyte from the source of electrolyte or one or more measured characteristics of a treated aqueous solution generated in the actinic radiation reactor.

In some embodiments, the system further comprises a sensor configured to measure a concentration of hydrogen peroxide in treated aqueous solution downstream of the actinic radiation reactor.

In some embodiments, the system further comprises a controller in communication with the sensor and configured to adjust one or more operating parameters of the second electrochemical cell based on a measured concentration of the hydrogen peroxide.

In some embodiments, the one or more operating parameters of the second electrochemical cell include one or more of power applied to the second electrochemical cell, flow rate of electrolyte into the second electrochemical cell, flow rate of sodium hypochlorite out of the second electrochemical cell, or concentration of sodium hypochlorite produced in the second electrochemical cell.

In some embodiments, the source of electrolyte includes the source of oxygen and the system further includes a recirculation conduit configured to return a solution including the hydrogen peroxide from the outlet of the electrochemical cell to the inlet of the electrochemical cell to form a recirculated solution, a source of water to be treated in fluid communication via a first conduit with the inlet of the actinic radiation reactor, and a second conduit providing selective fluid communication from the recirculation conduit to a point of introduction in the first conduit upstream of the inlet of the actinic radiation reactor.

In some embodiments, the system further comprises a valve configured to transition from a closed state to an at least partially open state and direct the recirculated solution into the water to be treated through the point of introduction responsive to a concentration of hydrogen peroxide in the recirculated solution reaching a predetermined level.

In some embodiments, the system further comprises a controller operatively connected to one or more sensors, the one or more sensors configured to measure one or more of flow rate of the water to be treated, a concentration of a contaminant in the water to be treated, a concentration of hydrogen peroxide in the water to be treated, a purity of product water exiting the actinic radiation reactor, a flow rate of the product water exiting the actinic radiation reactor, or a concentration of hydrogen peroxide in the recirculated solution.

In some embodiments, the controller is configured to adjust one or more operating parameters of the system based on one or more signals received from the one or more sensors, the one or more operating parameters including one or more of the state of the valve, power applied to the electrochemical cell, power applied to the actinic radiation reactor, flow rate of electrolyte through the electrochemical cell, flow rate of water to be treated through the actinic radiation reactor, or dosage of radiation applied to the water to be treated in the actinic radiation reactor.

In some embodiments, the one or more sensors is configured to measure the concentration of the hydrogen peroxide in the recirculated solution and the controller is configured to receive an indication of the concentration of the hydrogen peroxide in the recirculated solution from the sensor and send a signal to the valve to at least partially open responsive to the concentration of the hydrogen peroxide being at or above the predetermined level.

In some embodiments, the controller is further configured to set the predetermined level based on one or both of the concentration of the contaminant in the water to be treated or a desired purity of the product water.

In some embodiments, the controller is further configured to set the predetermined level based on a desired dosage of UV radiation to be applied to the water to be treated in the actinic radiation reactor.

In some embodiments, the controller is further configured to set the dosage of UV radiation to be applied to the water to be treated in the actinic radiation reactor based on one or more of the predetermined level, the concentration of the contaminant in the water to be treated, the flow rate of the water to be treated, or a desired purity of the product water.

In some embodiments, the controller is further configured to set the power applied to the electrochemical cell based on one or both of the concentration of the contaminant in the water to be treated or a desired purity of the product water.

In some embodiments, the controller is further configured to set the dosage of UV radiation to be applied to the water to be treated in the actinic radiation reactor based on the concentration of the contaminant in the water to be treated and a desired purity of the product water.

In some embodiments, the controller is further configured to set an amount of oxygen to be introduced into the electrolyte based on the predetermined level.

In some embodiments, the controller is further configured to set an amount of power applied to the electrochemical cell based on a desired amount of time within which to achieve the predetermined concentration level of hydrogen peroxide in the solution in the recirculation conduit.

In some embodiments, the controller is further configured to set the dosage of UV radiation to be applied to the water to be treated in the actinic radiation reactor based on the power applied to the electrochemical cell. In accordance with another aspect, there is provided a method of treating water in a water treatment system. The method comprises directing water to be treated from a source of water into a conduit fluidically coupled to an outlet of an electrochemical cell, adding hydrogen peroxide generated in the electrochemical cell to the water to be treated to form an aqueous solution including hydrogen peroxide, directing the aqueous solution into an inlet of an actinic radiation reactor, exposing the aqueous solution to sufficient actinic radiation in the actinic radiation reactor to generate free radicals in the aqueous solution which react with contaminants in the aqueous solution to form a treated aqueous solution, and directing the treated aqueous solution through a second conduit from an outlet of the actinic radiation reactor to a point of use.

In some embodiments, directing the water to be treated from the source of water into the conduit fluidically coupled to the outlet of the electrochemical cell includes directing the water to be treated into an inlet of the electrochemical cell.

In some embodiments, the method further comprises applying power across electrodes of the electrochemical cell to convert oxygen in the water to be treated to hydrogen peroxide in the electrochemical cell and form the aqueous solution including hydrogen peroxide, and directing the aqueous solution from an outlet of the electrochemical cell into the inlet of the actinic radiation reactor.

In some embodiments, exposing the aqueous solution to actinic radiation in the actinic radiation reactor includes exposing the aqueous solution to ultraviolet light in the actinic radiation reactor.

In some embodiments, directing the treated aqueous solution to the point of use includes directing the treated aqueous solution to the source of water.

In some embodiments, the method further comprises adding oxygen to the water to be treated upstream of the inlet of the electrochemical cell.

In some embodiments, the method further comprises recirculating the aqueous solution through a recirculation conduit from the outlet of the electrochemical cell to the inlet of the electrochemical cell for additional treatment in the electrochemical cell. The additional treatment increases a concentration of hydrogen peroxide in the aqueous solution. The method further comprises directing water to be treated from a second source of water to be treated through a first conduit into the inlet of the actinic radiation reactor, and providing selective fluid communication from the recirculation conduit to a point of introduction in the first conduit upstream of the inlet of the actinic radiation reactor.

In some embodiments, the method further comprises measuring a concentration of the hydrogen peroxide in the recirculation conduit with a sensor.

In some embodiments, the method further comprises receiving, at a controller, an indication of the concentration of the hydrogen peroxide in the recirculation conduit from the sensor, and sending a signal to a valve providing selective fluid communication between the recirculation conduit and the first conduit to at least partially open responsive to the indication of the concentration of the hydrogen peroxide in the recirculation conduit being an indication of the concentration being at or above a predetermined level.

In some embodiments, the method further comprises measuring, with one or more sensors operatively connected to a controller of the system, one or more of flow rate of the water to be treated, a concentration of a contaminant in the water to be treated, a concentration of hydrogen peroxide in the water to be treated, a purity of product water exiting the actinic radiation reactor, a flow rate of the product water exiting the actinic radiation reactor, or a concentration of hydrogen peroxide in the recirculated solution.

In some embodiments, the method further comprises adjusting, with the controller, one or more operating parameters of the system based on one or more signals received from the one or more sensors, the one or more operating parameters including one or more of a state of the valve, power applied to the electrochemical cell, power applied to the actinic radiation reactor, flow rate of electrolyte through the electrochemical cell, flow rate of water to be treated through the actinic radiation reactor, or dosage of radiation applied to the water to be treated in the actinic radiation reactor.

In some embodiments, the method further comprises measuring the concentration of the hydrogen peroxide in the aqueous solution in the recirculation conduit with the one or more sensors, receiving, by the controller, an indication of the concentration of the hydrogen peroxide in the aqueous solution in the recirculation conduit from one or more sensors, and sending a signal to a valve providing selective fluid communication between the recirculation conduit and the conduit to at least partially open responsive to the concentration of the hydrogen peroxide being at or above the predetermined level.

In some embodiments, the method further comprises setting the predetermined level based on one or both of the concentration of the contaminant in the water to be treated or a desired purity of the product water.

In some embodiments, the method further comprises setting the predetermined level based on a desired dosage of UV radiation to be applied to the water to be treated in the actinic radiation reactor.

In some embodiments, the method further comprises setting the dosage of UV radiation to be applied to the water to be treated in the actinic radiation reactor based on one or more of the predetermined level, the concentration of the contaminant in the water to be treated, the flow rate of the water to be treated, or a desired purity of the product water.

In some embodiments, the method further comprises setting the power applied to the electrochemical cell based on one or both of the concentration of the contaminant in the water to be treated or a desired purity of the product water.

In some embodiments, the method further comprises setting the dosage of UV radiation to be applied to the water to be treated in the actinic radiation reactor based on the concentration of the contaminant in the water to be treated and a desired purity of the product water.

In some embodiments, the method further comprises setting an amount of oxygen to be introduced into the electrolyte based on the predetermined level.

In some embodiments, the method further comprises setting an amount of power applied to the electrochemical cell based on a desired amount of time within which to achieve the predetermined concentration level of hydrogen peroxide in the aqueous solution in the recirculation conduit.

In some embodiments, the method further comprises setting the dosage of UV radiation to be applied to the water to be treated in the actinic radiation reactor based on the power applied to the electrochemical cell.

In some embodiments, the method further comprises electrochemically generating a chemical agent that quenches hydrogen peroxide in a second electrochemical cell having an outlet fluidically coupled to the second conduit.

In some embodiments, the method further comprises controlling an amount of the chemical agent introduced into the second conduit based on a concentration of hydrogen peroxide in the treated aqueous solution.

In some embodiments, controlling the amount of the chemical agent introduced into the second conduit includes one or more of, controlling a flow rate of the chemical agent from the second electrochemical cell into the second conduit, controlling power applied to the second electrochemical cell, or controlling a flow rate the chemical agent from a storage tank in fluid communication with an outlet of the second electrochemical cell.

In some embodiments, the method further comprises flowing the treated aqueous solution through the second electrochemical cell and generating the chemical agent from dissolved species in the treated aqueous solution.

In accordance with another aspect, there is provided a method of retrofitting a water treatment system including an advanced oxidation process reactor in fluid communication with a source of water to be treated. The method comprises installing an electrochemical cell having an outlet in fluid communication between the source of water to be treated and the advanced oxidation process reactor, and providing instructions to operate the electrochemical cell to convert oxygen in the water to be treated to hydrogen peroxide.

In some embodiments, the method further comprises providing a sensor configured to measure a concentration of one or more contaminants in water one of upstream of the actinic radiation reactor or downstream of the actinic radiation reactor.

In some embodiments, the method further comprises providing a controller in communication with the sensor and configured to adjust one or more operating parameters of the system responsive to a measured concentration of the one or more contaminants.

In some embodiments, the one or more operating parameters including one of power applied to the electrochemical cell, power applied to the actinic radiation reactor, and flow rate of electrolyte or aqueous solution through one of the electrochemical cell or actinic radiation reactor.

In some embodiments, the method further comprises providing a recirculation conduit configured to return aqueous solution from an outlet of the electrochemical cell to an inlet of the electrochemical cell to form a recirculated solution.

In some embodiments, the method further comprises providing a controller operatively connected to one or more sensors, the one or more sensors configured to measure one or more of flow rate of the water to be treated, a concentration of a contaminant in the water to be treated, a concentration of hydrogen peroxide in the water to be treated, a purity of product water exiting the advanced oxidation process reactor, a flow rate of the product water exiting the advanced oxidation process reactor, or a concentration of hydrogen peroxide in the recirculated brine solution.

In some embodiments, the method further comprises configuring the controller to adjust one or more operating parameters of the system based on one or more signals received from the one or more sensors, the one or more operating parameters including one or more of, power applied to the electrochemical cell, power applied to the advanced oxidation process reactor, flow rate of electrolyte through the electrochemical cell, flow rate of water to be treated through the advanced oxidation process reactor, or dosage of radiation applied to the water to be treated in the advanced oxidation process reactor.

In some embodiments, the method further comprises installing a second electrochemical cell configured to electrochemically generate a chemical agent that quenches hydrogen peroxide having an outlet in fluid communication with an outlet of the advanced oxidation process reactor.

In some embodiments, the method further comprises controlling a rate of introduction of the chemical agent into a conduit fluidically coupled to the outlet of the advanced oxidation process reactor based on a concentration of hydrogen peroxide in treated aqueous solution exiting the outlet of the advanced oxidation process reactor.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a schematic illustration of an electrolytic cell configured to generate hydrogen peroxide from water and oxygen and associated reactions;

FIG. 1B is a schematic illustration of an electrolytic cell configured to generate chlorine from seawater and oxygen and associated reactions;

FIG. 2A is a cathodic voltammetric plot with velocity, water generation at 6.9 bar dissolved air;

FIG. 2B is a cathodic voltammetric plot with velocity, water generation at 6.9 bar dissolved O₂;

FIG. 3 is a cross-section of an example of a concentric tube electrode electrochemical cell for producing hydrogen peroxide;

FIG. 4 illustrates calculations for determining the amount of energy to produce hydrogen peroxide in an example of an electrochemical cell;

FIG. 5A is an isometric view of an embodiment of a concentric tube electrochemical cell;

FIG. 5B is a cross-sectional view of the concentric tube electrochemical cell of FIG. 5A;

FIG. 6A illustrates current flow through an embodiment of a concentric tube electrochemical cell;

FIG. 6B illustrates current flow through another embodiment of a concentric tube electrochemical cell;

FIG. 6C illustrates current flow through another embodiment of a concentric tube electrochemical cell;

FIG. 7 is an isometric view of an embodiment of a single pass spiral wound electrochemical cell;

FIG. 8 is an isometric view of another embodiment of a single pass spiral wound electrochemical cell;

FIG. 9 is a partial cross-sectional view of an embodiment of a three tube concentric tube electrochemical cell;

FIG. 10 is a partial cross-sectional view of an embodiment of a four tube concentric tube electrochemical cell;

FIG. 11 is a partial cross-sectional view of an embodiment of a five tube concentric tube electrochemical cell;

FIG. 12A illustrates the spectrum of radiation of a typical low pressure gas discharge ultraviolet lamp;

FIG. 12B illustrates the spectrum of radiation of a typical medium pressure gas discharge ultraviolet lamp;

FIG. 12C illustrates percent activation of hydrogen peroxide in advanced oxidation process reactors using low pressure or medium pressure ultraviolet lamps at different applied ultraviolet light energy doses;

FIG. 13 is a schematic drawing illustrating an actinic radiation reactor vessel in in accordance with one or more embodiments;

FIG. 14A is a schematic drawing illustrating a portion of an interior of the vessel of FIG. 13 in accordance with one or more embodiments;

FIG. 14B is a schematic drawing illustrating another portion of an interior of the vessel of FIG. 13 in accordance with one or more embodiments;

FIG. 15 illustrates an embodiment of system including an actinic radiation reactor vessel and an electrolytic cell upstream of the actinic radiation reactor vessel;

FIG. 16 illustrates another embodiment of system including an actinic radiation reactor vessel and an electrolytic cell upstream of the actinic radiation reactor vessel;

FIG. 17 illustrates another embodiment of system including an actinic radiation reactor vessel and an electrolytic cell upstream of the actinic radiation reactor vessel;

FIG. 18 illustrates another embodiment of system including an actinic radiation reactor vessel, an electrolytic cell upstream of the actinic radiation reactor vessel, and a source of quenching agent in fluid communication downstream of the actinic radiation reactor;

FIG. 19 is a piping and instrumentation diagram of a potential feed and bleed system;

FIG. 20 illustrates a control system that may be utilized for embodiments of water treatment systems disclosed herein;

FIG. 21 illustrates a memory system for the control system of FIG. 20;

FIG. 22 illustrates results of one test of an electrochemical cell for the production of hydrogen peroxide;

FIG. 23 illustrates results of a test of current vs. voltage across an electrolytic cell disposed with solutions having different concentrations of oxygen flowed through the cell at different flow rates;

FIG. 24 illustrates the results of testing of the effect of pH on contaminant destruction in a UV AOP reactor with H₂O₂ in solution;

FIG. 25 illustrates the results of testing of the effect of pH on activation of H₂O₂ in a UV AOP reactor;

FIG. 26 illustrates the results of testing of the effect of UV dosage and H₂O₂ concentration on 1,4-Dioxane destruction in a UV AOP reactor; and

FIG. 27 illustrates the results of testing of the effect of UV dosage and H₂O₂ concentration on Humic acid destruction in a UV AOP reactor

### DETAILED DESCRIPTION

Aspects and embodiments disclosed herein are not limited to the details of construction and the arrangement of components set forth in the following description or illustrated in the drawings. Aspects and embodiments disclosed herein are capable of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

One or more aspects disclosed herein relate to a method of treating contaminated wastewater. According to some embodiments, the method comprises providing a contaminated wastewater having an initial concentration of a recalcitrant organic contaminant to be treated, introducing a hydrogen peroxide to the contaminated wastewater to produce an aqueous solution including hydrogen peroxide, and exposing the aqueous solution to ultraviolet light to produce a treated aqueous solution, where the treated aqueous solution has a concentration of the recalcitrant organic contaminant that is at least 50% less than the initial concentration of recalcitrant organic contaminant. The treated aqueous solution may also be referred to as product water or simply product herein.

In some embodiments, the treated aqueous solution is further treated to remove residual hydrogen peroxide, for example, by the addition of a chemical that causes hydrogen peroxide to break down. One suitable chemical for quenching hydrogen peroxide is sodium hypochlorite. The reaction between sodium hypochlorite and hydrogen peroxide creates salt, water, and oxygen in accordance with the formula:

NaOCl+H₂O₂→NaCl+H₂O+O₂

Other chemicals such as gaseous chlorine, chloramines, or thiosulfates may additionally or alternatively be used to quench residual hydrogen peroxide. In further embodiments, the treated aqueous solution may be passed through a bed of activated carbon to quench or break down residual hydrogen peroxide.

According to certain aspects, the method can further comprise measuring a total organic carbon (TOC) value of the contaminated wastewater to be treated. The method may further comprise adjusting at least one of a rate at which the hydrogen peroxide is introduced to the contaminated wastewater and a dose of the ultraviolet light based on the measured TOC value. According to a further aspect, adjusting a dose of the ultraviolet light comprises at least one of adjusting an intensity of the UV light and adjusting an exposure time of the UV light to the first treated aqueous solution. According to another aspect, adjusting an exposure time of the UV light comprises adjusting a flow rate of the aqueous solution. According to yet another aspect, adjusting an exposure time of the UV light comprises adjusting a residence time of the aqueous solution in a reactor.

According to at least one aspect, the method can further comprise measuring a TOC value of the treated aqueous solution. According to at least one aspect, the method further comprises recirculating at least a portion of the treated aqueous solution to a point upstream from the introduction of the hydrogen peroxide based on the measured TOC value of the treated aqueous solution. According to some aspects, the method further comprises adjusting at least one of a rate at which the hydrogen peroxide is introduced to the contaminated wastewater and a dose of the ultraviolet light based on the measured TOC value of the treated aqueous solution.

Methods and systems disclosed herein may also involve measurement of a concentration of residual hydrogen peroxide in the treated aqueous solution after exposure to UV radiation, for example, downstream of a UV reactor. The concentration of hydrogen peroxide may be determined from, for example, measurements of oxidation-reduction potential (ORP) of the treated aqueous solution. Measurements of ORP in samples of water having different concentrations of hydrogen peroxide may be compared to determinations of the hydrogen peroxide concentration in the samples of water made by other methods, for example, titration, to generate a calibration curve of ORP vs. hydrogen peroxide concentration. In other embodiments, samples of the treated aqueous solution may be periodically taken and the concentration of hydrogen peroxide in the samples directly determined via, for example, titration. One or more of the rate or concentration of hydrogen peroxide introduced into the contaminated wastewater, the dose of UV radiation applied to the aqueous solution, or the rate of addition or concentration of an agent introduced to the treated aqueous solution to quench residual hydrogen peroxide may be adjusted based at least in part on the amount or concentration of residual hydrogen peroxide in the treated aqueous solution.

In accordance with various aspects, the aqueous solution is a first treated stream and the treated aqueous solution is a second treated stream and the hydrogen peroxide is introduced to the contaminated wastewater upstream from the exposure of the first treated stream to the ultraviolet light. According to one aspect, the concentration of recalcitrant organic contaminant in the second treated aqueous solution is at least 99% less than the initial concentration of contaminant. According to at least one aspect, the method can further comprise pretreating the contaminated wastewater. According to a further aspect, pretreating the contaminated wastewater comprises introducing the contaminated wastewater to a media filter prior to introducing the hydrogen peroxide.

In accordance with certain aspects, the hydrogen peroxide is introduced to the contaminated wastewater or wastewater and the wastewater including the hydrogen peroxide (the aqueous solution) is exposed to the UV radiation in a single pass.

According to at least one aspect, the treated aqueous solution is potable water. According to another aspect, the method may further comprise extracting the contaminated wastewater or groundwater from a remediation site.

One or more aspects disclosed herein relate to a system for treating contaminated wastewater. The terms “contaminated water” and “water to be treated” should be considered synonymous herein. In some embodiments, the system comprises a source of contaminated wastewater having an initial concentration of a recalcitrant organic contaminant, a TOC concentration sensor in fluid communication with the contaminated wastewater, a source of hydrogen peroxide fluidly connected to the source of contaminated wastewater and configured to introduce hydrogen peroxide to the contaminated wastewater to produce an aqueous solution including hydrogen peroxide, an actinic radiation source fluidly connected to the source of contaminated wastewater and configured to irradiate the aqueous solution, and a controller in communication with the TOC concentration sensor and configured to control at least one of a rate at which the hydrogen peroxide is introduced to the contaminated wastewater and a dose of irradiation applied by the actinic radiation source based at least in part on an output signal from the TOC concentration sensor.

According to certain aspects, the system further comprises a reactor fluidly connected to the source of contaminated wastewater and the source of hydrogen peroxide and configured to house the actinic radiation source. According to another aspect, the controller is configured to control the dose of irradiation by controlling a residence time of the aqueous solution in the reactor. According to yet another aspect, the controller is configured to control the dose of irradiation by controlling a flow rate of the contaminated wastewater or aqueous solution. According to a further aspect, the actinic radiation source is positioned downstream from the source of hydrogen peroxide. According to at least one aspect, the TOC concentration sensor is positioned upstream from the source of hydrogen peroxide. According to another aspect, the TOC concentration sensor is a first TOC concentration sensor and the system further comprises a second TOC concentration sensor in communication with the controller and positioned downstream from the actinic radiation source. According to certain aspects, the controller is configured to control at least one of the rate at which the hydrogen peroxide is introduced to the contaminated wastewater, and a dose of irradiation applied by the actinic radiation source based at least in part on an output signal from the second TOC concentration sensor.

According to certain aspects, the system includes a sensor for measuring residual hydrogen peroxide in the treated water downstream of the actinic radiation source or reactor. The system may further comprise a source of an agent that quenches residual hydrogen peroxide that introduces the agent into the treated water downstream of the actinic radiation source or reactor. The controller may be further configured to control one or more of the rate or concentration of hydrogen peroxide introduced into the contaminated wastewater, the dose of UV radiation applied to the aqueous solution, or the rate of addition or concentration of the agent to quench residual hydrogen peroxide in the treated water based at least in part on an output signal from the sensor for measuring residual hydrogen peroxide in the treated water.

One or more aspects can be directed to wastewater treatment systems and techniques. The systems and techniques may utilize a hydrogen peroxide dosing system in combination with a source of ultraviolet (UV) light to treat wastewater contaminated with a recalcitrant organic contaminant. According to some embodiments, the wastewater is treated such that the concentration of recalcitrant organic contaminant is reduced to levels such that the wastewater may be pumped back into the ground, i.e., the level of recalcitrant organic contaminant falls below one or more standards set by governing authorities. According to a further aspect, the concentration of recalcitrant organic contaminant is reduced such that the treated wastewater may be characterized as potable water. For example, according to some embodiments, the methods and systems disclosed herein may treat contaminated wastewater to produce potable water. The potable water may comply with standards set by municipalities. As used herein the term “recalcitrant organic” when used in reference to a contaminant refers to organic compounds that resist microbial degradation or are not readily biodegradable. In certain instances, the recalcitrant organic contaminant may not degrade biologically, and remediation methods may be unable to remove enough of the substance to satisfy environmental regulations. Non-limiting examples of recalcitrant organic contaminants include 1,4-dioxane, trichloroethylene (TCE), perchloroethylene (PCE), urea, isopropanol, chloroform, atrazine, tryptophan, and formic acid. Tables 1A-1D below list non-limiting examples of recalcitrant organic contaminants that may be present in wastewater treated by the systems and techniques disclosed herein and that may be removed from the wastewater or decomposed or oxidized by the systems and techniques disclosed herein.

Tables 1A and 1B below lists various types of organic contaminants and examples that may be treated or decomposed or oxidized by the systems and methods disclosed herein.

TABLE 1A
Anions (not oxidized, but decomposed)
Chlorate
Bromate
Halogenated Alkanes
1,2,3-trichloropropane (1,2,3-TCP)
1,1-dichloroethane
1,2-dichloroethane
Trihalomethanes (Trichloromethane, Monochlorodibromomethane, etc.)
Bromomethane
Chloromethane
Halogenated Alkenes
Tetrachloroethene
Trichloroethene
1,2-cis-dichloroethene
1,2-trans-dichloroethene
Vinyl Chloride
Alkynes
Acetylene
Dichloroethylene
TCE Trichloroethylene
PCE Tetrachloroethylene
Halogentated Organic Acids
Haloacetic Acids (Trichloro aceticacid, monochloroaceticacid,
monochlorodibromoacetic acid, iodoacetic acids, etc.)
Amines
Methylamine
Ethanolamine
Diphenylamine
Aniline
Piperidine
Methylethanolamine
Trimethylamine
Nitrosamines
NDMA, N-Nitrosodimethylamine
Surfactants/Algacides/Bactericides
Quaternary ammonium alkyl halides
Alcohols
Methanol
Ethanol
Isopropanol
Butanol
PentanoI
Hexanol
TBA (Tert Butyl Alcohol)
Acetic Acids
Monochloroacetic Acid
Dichloroacetic Acid
Iodoacetic Acid
PTFE Precursors
PFOA
PFOS
PFNA
Ethers/Aldehydes
1,4-dioxane
Formaldehyde
Diethyl ether
Polyethylene glycol
MTBE (Methyl Tertbutyl Ether)
Ketones
2-pentanone (MPK)
butanone (MEK)
Organisms
Bacteria
Molds
Fungi
Viruses (including entero & noro)

TABLE 1B
Pharmaceuticals and Personal Care Products

Acetaminophen
Androstenedione
Atrazine
Benzo[a]pyrene
Caffeine
Carbamazepine
DDT
DEET
Diazepam
Diclofenac
Dilantin
Erythromycin
Estradiol
Estriol
Estrone
Ethinylestradiol
Fluorene
Fluoxetine
Galaxolide
Gemfibrozil
Hydrocodone
Ibuprofen
lopromide
Lindane
Meprobamate
Metolachlor
Musk Ketone
Naproxen
Oxybenzone
Pentoxifylline
Progesterone
Sulfamethoxazole
TCEP
Testosterone
Triclosan
Trimethoprim
Unreacted Monomers
Acrylonitrile
Vinyl chloride
Propylene
Styrene
Urethane
Cyclic siloxanes
Hexamethylcyclotrisiloxane
Decamethylcyclopentasiloxane
Linear siloxanes
Octamethyltrisiloxane
Dodecamethylpentasiloxane
Ammonia
Sulfur Bearing Compounds
Hydrogen Sulfide
Dimethyl Disulfide
Dimethyl Sulfide
Carbonyl Sulfide
Polyaromatic Hydrocarbons
Naphthalene
Fluorene
Anthracene
Aromatic Hydrocarbons
Benzene
Cumene
Xylene
Phenol
Benzoate
Benzylamine
Benzylacetate
Halogenated Aromatics
Benzyl chloride
Benzyl bromide
Chlorophenol

Table 1C lists additional examples of various recalcitrant organic contaminants and their respective class that may be treated or decomposed or oxidized by the methods and systems disclosed herein. One or more of these compounds may be endocrine disruptors. Endocrine disruptors may refer to an exogenous chemical substance which inhibits or promotes various processes such as the homeostasis of the living body, and synthesis, storage, secretion, internal transport, receptor binding, hormone activity and excretion of various internal hormones involved in reproduction, development and behavior, and is also a term which may also be named an exogenous endocrine disrupting substance, an endocrine disrupting substance, an endocrine disrupting chemical substance, an endocrine disorder substance, or an environmental hormone.

TABLE 1C

| Contaminant | Class |
|---|---|
| Acetaminophen | Pharmaceutical |
| Androstenedione | Steroid |
| Atrazine | Pesticide |
| Benzo[a]pyrene | PAH (polycyclic aromatic hydrocarbon) |
| Caffeine | PCP (personal care product) |
| Carbamazepine | Pharmaceutical |
| DDT | Pesticide |
| DEET | PCP |
| Diazepam | Pharmaceutical |
| Diclofenac | Pharmaceutical |
| Dilantin | Pharmaceutical |
| Erthromycin-H20 | Antimicrobial |
| Estadiol | Steroid |
| Estriol | Steroid |
| Estrone | Steroid |
| Ethinylestradiol | Steroid |
| Fluorene | PAH |
| Fluoxetine | Pharmaceutical |
| Galaxolide | Fragrance |
| Gemfibrozil | Pharmaceutical |
| Hydrocodone | Pharmaceutical |
| Ibuprofen | Pharmaceutical |
| Iopromide | Pharmaceutical |
| Lindane | Pesticide |
| Meprobamate | Pharmaceutical |
| Metolachlor | Pesticide |
| Musk Ketone | Fragrance |
| Naproxen | Pharmaceutical |
| Oxybenzone | PCP |
| Pentoxifylline | Pharmaceutical |
| Progesterone | Steroid |
| Sulfamethoxazole | Antimicrobial |
| TCEP | PCP |
| Testosterone | Steroid |
| Triclosan | Antimicrobial |
| Trimethoprim | Antimicrobial |

Table 1D includes non-limiting examples of pharmaceutical and personal care product compounds that may be treated or decomposed or oxidized by the systems and methods disclosed here. One or more of these substances may also be endocrine disruptors.

TABLE 1D
Pharmaceuticals

| | |
|---|---|
| Trimethoprim, crytomycine, lincomycin, | Veterinary & human |
| sultamethaxole, chloramphenicol, amoxycillin | antibiotics |
| Ibuprofen, diclofenac, fenoprofen, | Analgesics & |
| acetaminophen, naproxen, acetylsalicyclic | anti-inflammatory drugs |
| acid, fluoxetine, ketoprofen, indometacine, | |
| paracetamol | |
| Diazepam, carbamazepine, primidone, | Psychiatric drugs |
| salbutamol | |
| Clofibric acid, bezafibrate, fenofibric acid, | Lipid regulators |
| etofibrate, gemfibrozil | |
| Metoprolol, propranolol, timolol, sotalol, | B-Blockers |
| atenolol | |
| Iopromide, iopamidol, diatrizoate | X-ray contrasts |
| Estradiol, estrone, estriol, diethylstilbestrol | Steroids & hormones |
| (DES) | |
| Nitro, polycyclic and macrocyclic musks, | Personal care products |
| phthalates | and Fragrances |
| Benzophenone, methylbenzylidene camphor | Sun-screen agents |
| N,N-diethyltoluamide | Insect repellants |
| Triclosan, chlorophene | Antiseptics |

In accordance with at least one aspect, some embodiments involve a method for treating contaminated wastewater. In addition, the process may be used to remediate contaminated groundwater. As used herein, the term “groundwater” may refer to water recoverable from subterranean sources as well as water recovered from surface bodies of water, such as streams, ponds, marshes, and other similar bodies of water. The wastewater or groundwater may be contaminated with a recalcitrant organic contaminant, as discussed above. The wastewater may have become contaminated from any one of a number of different sources, such as industrial processes, agricultural process, such as pesticide and herbicide applications, or other processes, such as disinfection processes that produce undesirable byproducts such as trihalomethanes.

In accordance with at least one embodiment, the methods and systems disclosed herein may include providing a contaminated wastewater having an initial concentration of a recalcitrant organic contaminant. According to some embodiments, the methods and systems disclosed herein may include extracting or otherwise removing the contaminated wastewater. For instance, the contaminated wastewater may be pumped from the ground or other sources using one or more pumps or other extraction devices as part of a remediation effort. Once treated, the wastewater may then be discharged or sent on for further processing. According to some embodiments, the contaminated wastewater is pumped or otherwise removed to the surface grade level where it may then be treated according to the processes and methods discussed herein. For example, according to some embodiments, the methods and systems disclosed herein may include extracting the contaminated wastewater from a remediation site. In at least one embodiment, one or more extraction wells and extraction equipment, such as pumps, may be used for pumping contaminated wastewater to the surface to be treated. Once treated, a pump or other distribution system may be used to re-inject the treated wastewater or groundwater back into the ground or otherwise re-introduce the treated wastewater back into the environment. In certain instances the contaminated wastewater may be stored in a holding tank or vessel prior to treatment, and in some cases treated water produced by the processes disclosed herein may be added or otherwise mixed with the contaminated wastewater.

In accordance with one or more aspects, the contaminated wastewater may have a level of total dissolved solids (TDS) that is in a range of about 100 mg/L to about 5000 mg/L, and in some instances may be in a range of about 200 mg/L to about 2000 mg/L, although these values can vary depending on the geographic location and other factors. As a source of comparison, water with a TDS level of 1000-1500 mg/L is considered drinkable, with some standards having a 500 mg/L TDS limit for domestic water supplies.

In accordance with another aspect, the methods and systems disclosed herein may be connected or otherwise in fluid communication with a source of contaminated wastewater. For instance, the contaminated wastewater may be pumped or otherwise delivered to the disclosed system for treatment.

According to various aspects, the concentration of recalcitrant organic contaminant in the wastewater is high enough to exceed limits established by government agencies. According to some embodiments, the systems and methods disclosed herein treat the wastewater such that the concentration level of the recalcitrant organic contaminant is reduced. In some instances, the systems and methods disclosed herein reduce the concentration of the recalcitrant organic contaminant to a level that complies with government standards or guidelines. According to one embodiment, the concentration of recalcitrant organic contaminant is reduced to a level such that the treated wastewater may be reintroduced back into the environment. For example, the EPA's standard for the concentration of 1,4-dixoane in drinking water is 1 μg/L (1 ppb). The methods and systems disclosed herein may be scaled to treat substantially all concentrations of recalcitrant organic contaminant that may be present in the wastewater. For instance, according to some embodiments, the initial concentration of recalcitrant organic contaminant, such as dioxane, in the wastewater may be in a range from about 5 ppb to about 800 ppb.

Aspects and embodiments disclosed herein may include unique designs and process streams for the on-site generation of hydrogen peroxide that could be used in an advanced oxidation process.

Advanced oxidation processes (AOP) are a set of treatment procedures used to remove organic materials from wastewater. In many applications, these processes involve the use of UV light and hydrogen peroxide, specifically:

H₂O₂+UV→2.OH
(homolytic bond cleavage of the O—O bond of H₂O₂ leads to formation of 2.OH radicals)

State of the art electrochemical devices exist which employ gas diffusion electrodes (GDEs) for the generation of hydrogen peroxide for AOP. However, it has been demonstrated that such GDE based devices suffer from many deficiencies for this purpose, specifically due to the robustness of materials of construction at high pressures, performance limitations resulting from water hardness, and the distribution/delivery of pressurized gases.

Aspects and embodiments disclosed herein include a device for on-site electrochemical hydrogen peroxide generation, which can be coupled with AOP, eliminating the need for chemical delivery/storage and a reduction in cost for supplying the hydrogen peroxide. Aspects and embodiments disclosed herein may further include a device for on-site electrochemical generation of sodium hypochlorite, which may be used to quench residual hydrogen peroxide in a treated solution produced from the treatment of an aqueous solution containing hydrogen peroxide in a UV AOP system. In some embodiments, the same electrochemical cell or device may be utilized for the production of both hydrogen peroxide and sodium hypochlorite.

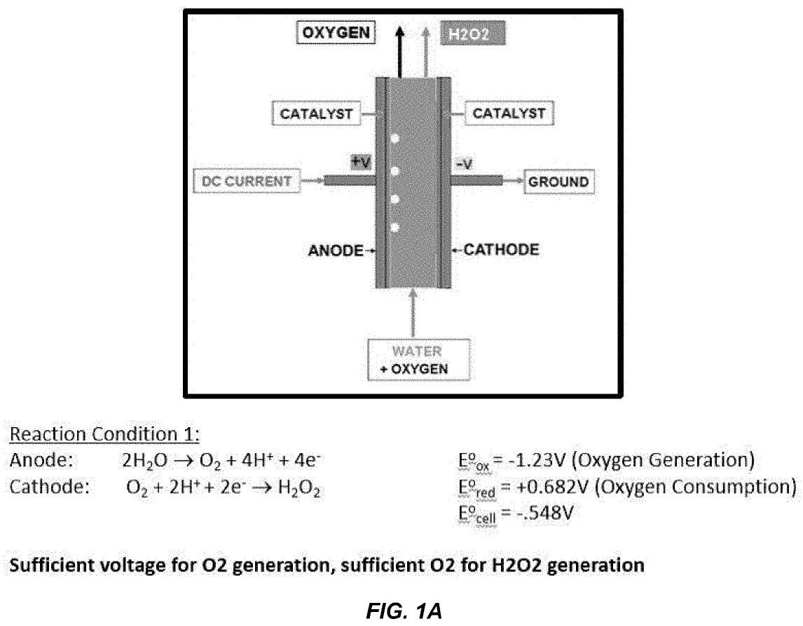

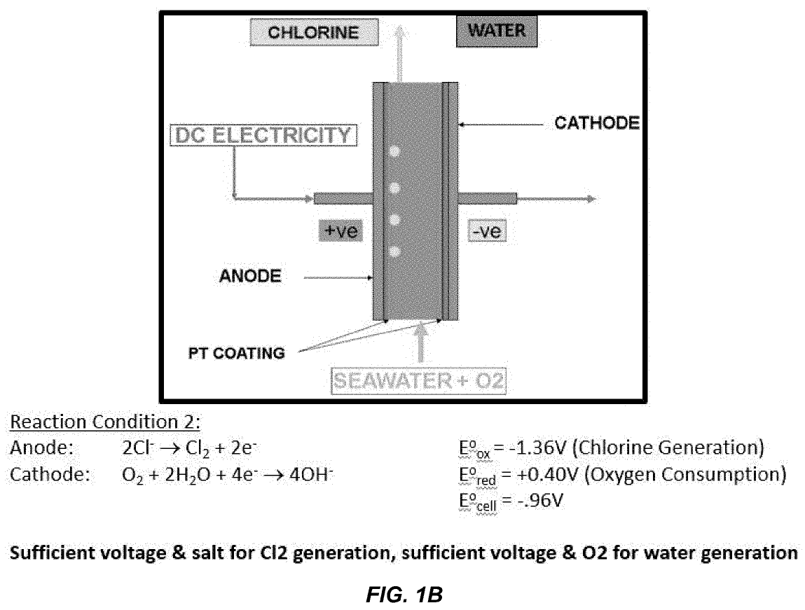

Consider the electrochemical reactions listed in FIGS. 1A and 1B. For an electrochemical cell with an aqueous process stream, and an appropriate catalyst on the anode (Ir, Pt, Ru, Mixed Metal Oxides (MMO) and combinations thereof), the overpotential for the O₂ generation reaction can be promoted (with or without the co-generation of sodium hypochlorite, as desired). Similarly, through the use of an appropriate catalyst on the cathode (Ir, Pt, Ru, Mixed Metal Oxides (MMO) and combinations thereof), and the pressurized delivery of high concentrations of dissolved oxygen, the overpotential for the H₂O₂ reaction can be promoted. These reactions are listed in FIG. 1A. In some embodiments, H₂O₂ may be generated in an electrochemical device having a cathode formed of a corrosion resistant material, for example, titanium without any catalyst. The cathode may have an active surface area less than an active surface area of the anode in an electrochemical cell for the generation of H₂O₂.

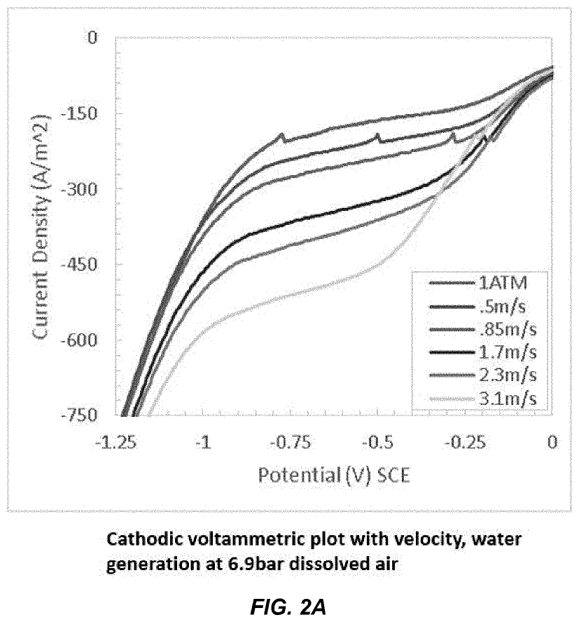

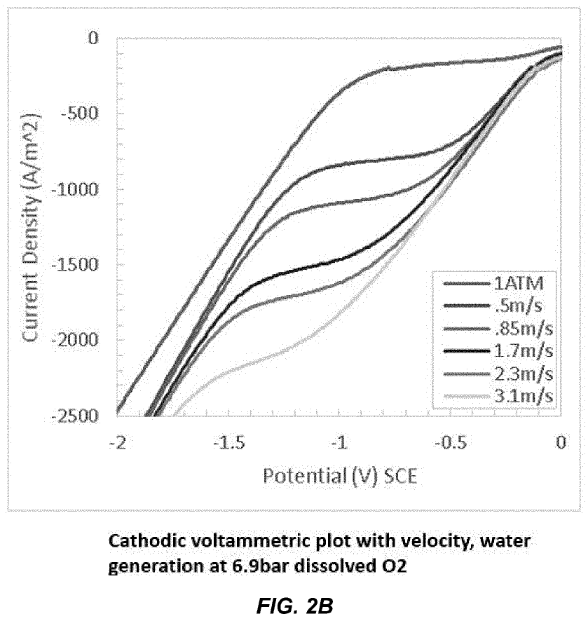

Electrochemical cells for the on-site generation of electrochemical reaction products are known in the art. In some embodiments, these devices include an inlet that receives a brine-based process stream, a catalytically active anode for the generation of sodium hypochlorite, and a catalytically active cathode for the reduction of O₂ to form water (FIG. 1B). These devices made use of high pressure (>1 ATM) and turbulent flow velocities (>2 m/s) to enhance their reaction kinetics, and using both pressurized air (6.9bar) and oxygen (6.9 bar) were able to achieve high current densities (˜600 A/m² and —2200 A/m², respectively) for the cathodic generation of water (FIGS. 2A, 2B).

FIGS. 2A and 2B are cathodic voltammetric plots of voltage and current across the anode and cathode of electrolytic cells with water flowing through the cells at different velocities. In these plots, the “1 ATM” curve represents the standard one atmosphere pressure condition at the 3.1 m/s peak velocity. The inflection points in the curves in these plots indicate changes in the type of reaction that is taking place. In FIG. 2A, points to the right of the inflection point in the uppermost curve at about 0.125 volts are voltage/current regimes in which hydrogen peroxide generation occurs in accordance with the reactions shown in FIG. 1A. Between the inflection points at about 0.125 volts and about 0.8 volts in the uppermost curve oxygen in the water is combining with hydrogen to form additional water. To the left of the inflection point at about 0.8 volts in the uppermost curve water splitting occurs to form oxygen and hydrogen.

FIG. 2B differs from FIG. 2A in that more oxygen was dissolved in the water used to generate the curves. The additional oxygen provided for increased kinetics of the electrochemical reactions, providing for higher currents to be achieved than in the reactions represented by the curves in FIG. 2A.

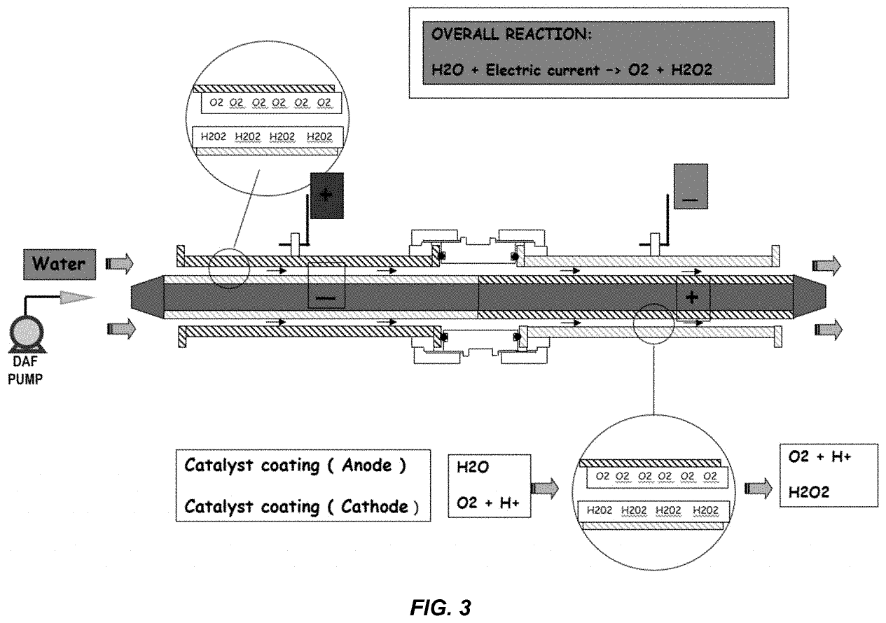

As the H₂O₂ generation reaction is more energetically favorable than the H₂O generation reaction (+0.682V vs. +0.4V), by shifting the applied potential it should also be possible to shift the reaction chemistries, and thus make use of existing electrochemical cell designs. Consider the non-limiting embodiment shown in FIG. 3. In this bipolar electrochemical cell, water and dissolved oxygen flow down the annular gap at a high velocity (>2 m/s). Electric current travels from an initial anode to an initial cathode, down the center tube, then exits a final anode to a final cathode. At each respective electrode surface, the reaction chemistries are as discussed above.

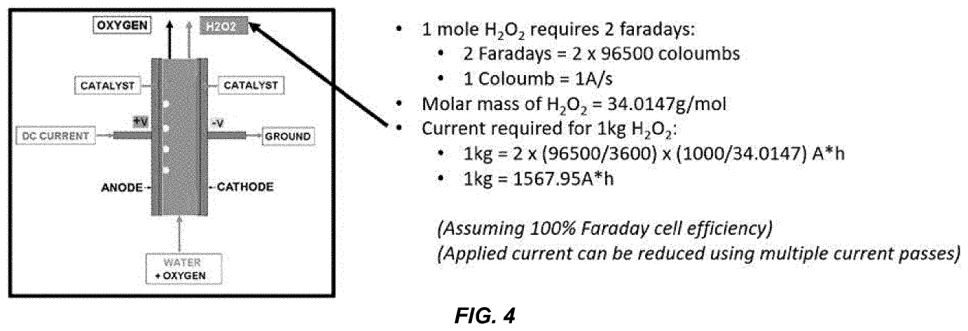

The calculation of required current per unit mass generation rate is listed in FIG. 4, specifically 1.57 kA/h per 1 kg (assuming 100% Faradaic efficiency). As electrode area is dependent upon the applied current density, based upon the parameters as shown in FIG. 2B, for a generation rate of 1 kg/h, an area of 0.71 m² might be anticipated (1.57 kA/(2.2 kA/m²)) in an embodiment as described in FIG. 3.

In accordance with at least one aspect, some embodiments thereof can involve a system for purifying or decreasing a concentration of undesirable components (contaminants) in a stream of water. The system can comprise one or more sources of water fluidly connected to at least one actinic radiation reactor. The at least one reactor may be configured to irradiate water from the source of water. The system can further comprise one or more sources of an oxidant, for example, hydrogen peroxide. The one or more sources of oxidant can be disposed to introduce one or more oxidants into the water from the one or more water sources.

The actinic radiation reactor may be a reactor including one or multiple ultraviolet (UV) lamps that produce ultraviolet light that, when absorbed by the one or more oxidants, causes free radicals, for example, OH to be produced from the one or more oxidants. The free radicals may oxidize dissolved organic carbon species in the water, for example, trichloromethane or urea, into less undesirable chemical species, for example, carbon dioxide and water. Embodiments of a treatment process for removing undesirable species, for example, organic carbon species from a fluid, for example, water, may be referred to herein an Advanced Oxidation Process (AOP) or a free radical scavenging process. These terms are used synonymously herein.

Aspects and embodiments disclosed herein are generally directed to AOP systems including UV reactors and electrochemical devices to generate oxidants such as hydrogen peroxide for introduction into the UV reactors to facilitate contaminant oxidation in the UV reactors, and to methods of use of such systems.

The terms “electrochemical device,” “electrochemical cell,” “electrolyzer” and grammatical variations thereof are to be understood to encompass “electrochlorination devices” and “electrochlorination cells” and grammatical variations thereof. Aspects and embodiments disclosed herein are described as including one or more electrodes. The term “metal electrodes” or grammatical variation thereof as used herein is to be understood to encompass electrodes formed from, comprising, or consisting of one or more metals, for example, titanium, aluminum, or nickel although the term “metal electrode” does not exclude electrodes including of consisting of other metals or alloys. In some embodiments, a “metal electrode” may include multiple layers of different metals. Metal electrodes utilized in any one or more of the embodiments disclosed herein may include a core of a high-conductivity metal, for example, copper or aluminum, coated with a metal or metal oxide having a high resistance to chemical attack by electrolyte solutions, for example, a layer of titanium, platinum, a mixed metal oxide (MMO), magnetite, ferrite, cobalt spinel, tantalum, palladium, iridium, silver, gold, or other coating materials. “Metal electrodes” may be coated with an oxidation resistant coating, for example, but not limited to, platinum, a mixed metal oxide (MMO), magnetite, ferrite, cobalt spinel, tantalum, palladium, iridium, silver, gold, or other coating materials. Mixed metal oxides utilized in embodiments disclosed herein may include an oxide or oxides of one or more of ruthenium, rhodium, tantalum (optionally alloyed with antimony and/or manganese), titanium, iridium, zinc, tin, antimony, a titanium-nickel alloy, a titanium-copper alloy, a titanium-iron alloy, a titanium-cobalt alloy, or other appropriate metals or alloys. Anodes utilized in embodiments disclosed herein may be coated with platinum and/or an oxide or oxides of one or more of iridium, ruthenium, tin, rhodium, or tantalum (optionally alloyed with antimony and/or manganese). Cathodes utilized in embodiments disclosed herein may be coated with platinum and/or an oxide or oxides of one or more of iridium, ruthenium, and titanium. Electrodes utilized in embodiments disclosed herein may include a base of one or more of titanium, tantalum, zirconium, niobium, tungsten, and/or silicon. Electrodes for any of the electrochemical cells disclosed herein can be formed as or from plates, sheets, screens, foils, extrusions, and/or sinters.

The term “tube” as used herein includes cylindrical conduits, however, does not exclude conduits having other cross-sectional geometries, for example, conduits having square, rectangular, oval, or obround geometries or cross-sectional geometries shaped as any regular or irregular polygon. The terms “concentric tubes” or “concentric spirals” as used herein includes tubes or interleaved spirals sharing a common central axis, but does not exclude tubes or interleaved spirals surrounding a common axis that is not necessarily central to each of the concentric tubes or interleaved spirals in a set of concentric tubes or interleaved spirals or tubes or interleaved spirals having axes offset from one another. Aspects and embodiments disclosed herein are not limited to the number of electrodes, the space between electrodes, the electrode material, material of any spacers between electrodes, number of passes within the electrochlorination cells, or electrode coating material.

This disclosure describes various embodiments of electrochlorination cells and electrochlorination devices that may be used in combination with UV reactors to perform advanced AOP processes.

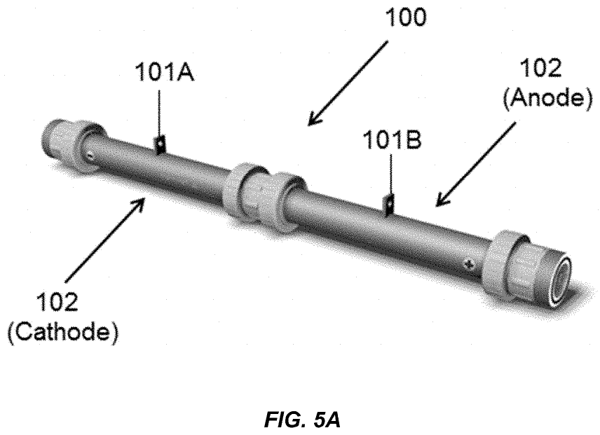

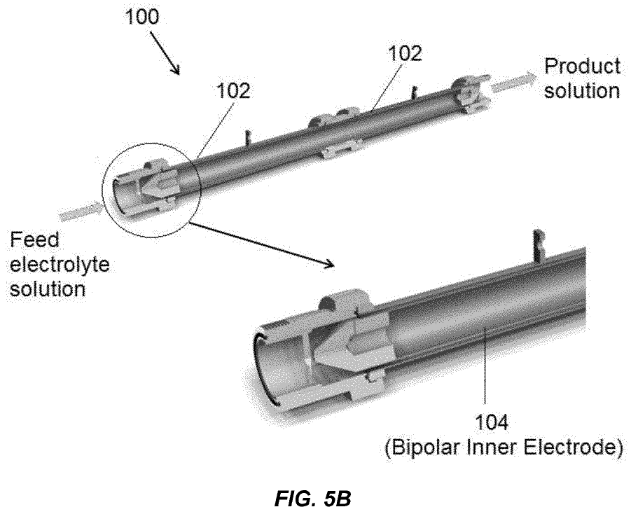

FIGS. 5A and 5B show an example of an electrochlorination cell 100 with concentric tubes 102, 104 manufactured by Electrocatalytic Ltd. The inner surface of the outer tubes 102 and the outer surface of the inner tube 104 are the active electrode areas. The gap between the electrodes is approximately 3.5 mm. The liquid velocity in the gap in the axial direction can be on the order of 2.1 m/s, resulting in highly turbulent flow which reduces the potential for fouling and scaling on the electrode surfaces. The high flow rate and turbulent flow of electrolyte through electrochlorination cells with concentric tubes as disclosed herein results in significant advantages in preventing scale formation due to hardness as compared to other to electrochemical cell configurations, for example, electrochemical cells with parallel plate electrodes.

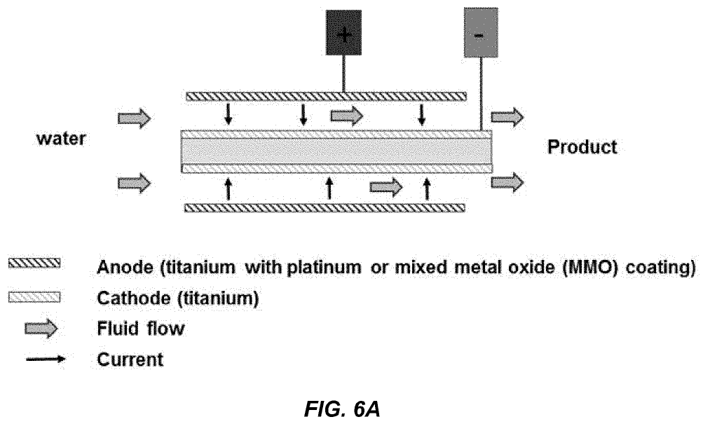

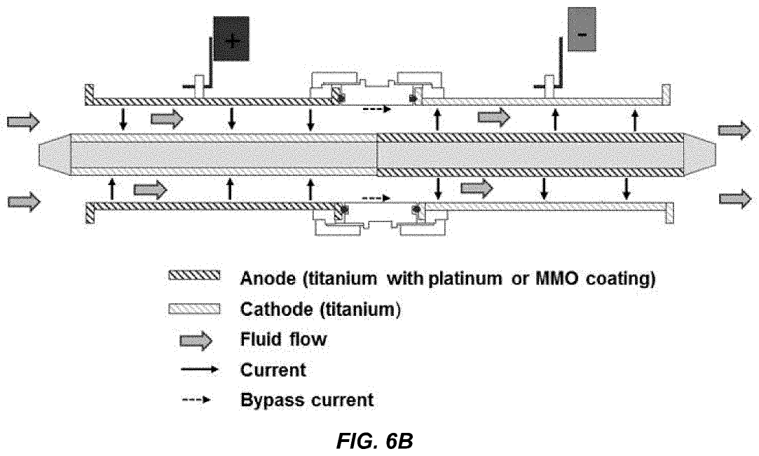

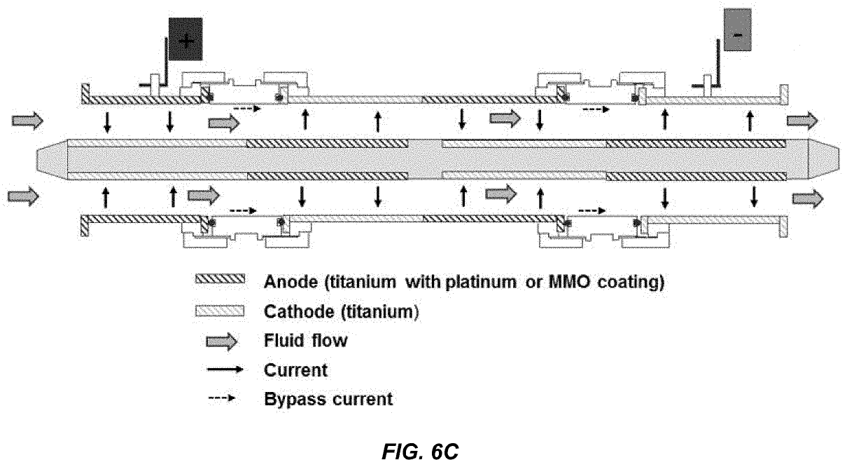

FIGS. 6A-6C show some possible arrangements of electrodes in a concentric tube electrode (CTE) electrochemical cell. FIG. 6A illustrates an arrangement in which current flows in one pass from the anode to the cathode. Both electrodes are typically fabricated from titanium, with the anode coated with platinum or a mixed metal oxide (MMO). The electrodes are called “mono-polar.”

FIG. 6B illustrates an arrangement in which current flows in two passes through the device with two outer electrodes and one inner electrode. One of the outer electrodes is coated on the inside surface to serve as an anode; the other is uncoated. A portion of the outer surface of the inner electrode is coated, also to serve as an anode, and the remaining portion is uncoated. Current flows through the electrolyte from the coated outer electrode to the uncoated portion of the inner electrode, along the inner electrode to the coated portion, then finally back across the electrolyte to the uncoated outer electrode. The inner electrode is also called a “bipolar” electrode.

FIG. 6C illustrates an arrangement in which current flows in multiple passes through the device with multiple outer electrodes and one inner electrode. By alternating coated and uncoated outer electrodes and coating the inner electrodes at matching intervals, current can flow back and forth through the electrolyte in multiple passes.

The rationale behind multiple passes is that the overall electrode area available for electrochemical reaction at the surface, and therefore the overall production rate of oxidant (e.g., hydrogen peroxide), can be increased without a proportional increase in applied current. Increasing the electrical current would require larger wires or bus bars from the DC power supply to the electrochlorination cell, larger electrical connectors on the cell (lugs 101A and 101B on the outside surface of the outer electrode in the example in FIG. 1A) and thicker titanium for the electrodes.

For the same current, a multiple pass device will have a higher production rate than a single pass cell but the overall voltage drop will be higher (approximately to proportional to the number of passes). For the same production rate, a multiple pass cell will require lower current (approximately inversely proportional to the number of passes). For the same power output (kW), power supply costs may be more sensitive to output current than output voltage, thereby favoring the multi-pass cells.

In actuality there are inefficiencies associated with a multiple pass cell. For example, a portion of the current, referred to as “bypass current,” can flow directly from an anode to a cathode without crossing the electrolyte in the gap between the outer and inner electrodes (see FIGS. 6B and 6C). The bypass current consumes power but results in less efficient production of oxidant than non-bypass current. Multiple pass cells are also more complex to fabricate and assemble. Portions of the outer surface of the inner electrode, for example, should be masked before the remaining portions are coated.

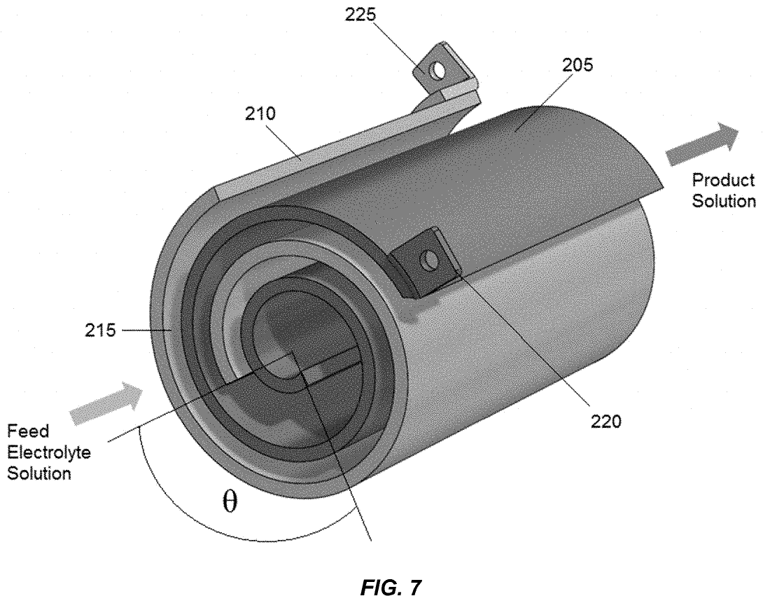

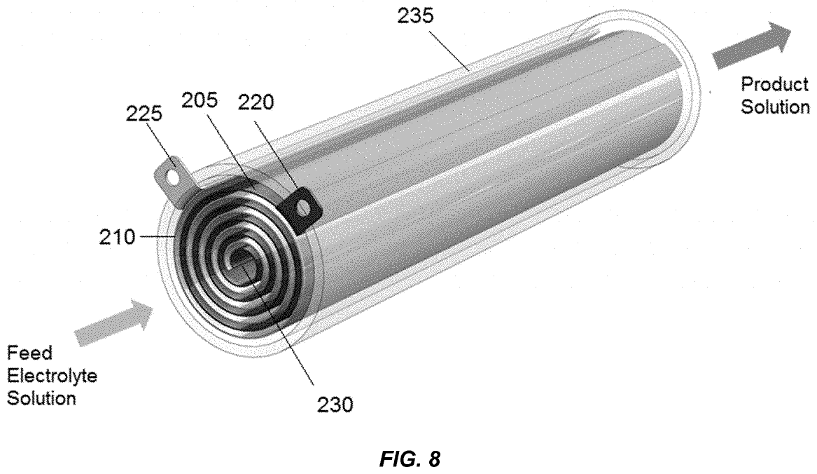

Aspects and embodiments disclosed herein may include electrochemical cells having spiral wound electrodes, non-limiting example of which are illustrated in FIGS. 7 and 8. In spiral wound configurations, two spiral-wound electrodes, an anode 205 and a cathode 210 forming an anode-cathode pair, are positioned to form a gap 215 in between the anode 205 and cathode 210. The angular difference between the starting ends of the helixes and/or the ending ends of the helixes, labeled 0 in FIG. 7, may range from 0° to 180°. A feed electrolyte solution flows through the gap 215 in a direction substantially parallel to the axes of the spirals. A DC voltage, constant or variable, or in some embodiments, AC current, is applied across the electrodes and through the electrolyte solution. An anode tab 220 and a cathode tab 225 are connected to or formed integral with the anode 205 and cathode 210, respectively, to provide electrical connection to the anode 205 and cathode 210. The current flows from the anode 205 to the cathode 210 in a single pass. Electrochemical and chemical reactions occur at the surfaces of the electrodes and in the bulk electrolyte solution in the electrochemical cell to generate a product solution.

The spiral wound electrodes 205, 210 may be housed within a housing 235 (See FIG. 8) designed to electrically isolate the electrodes from the outside environment and to withstand the fluid pressure of electrolyte passing through the electrochemical cell. The housing 235 may be non-conductive, chemically non-reactive to electrolyte solutions, and may have sufficient strength to withstand system pressures. In some embodiments, a solid core, central core element, or fluid flow director that prevents fluid from flowing down the center and bypassing the gap may be provided.

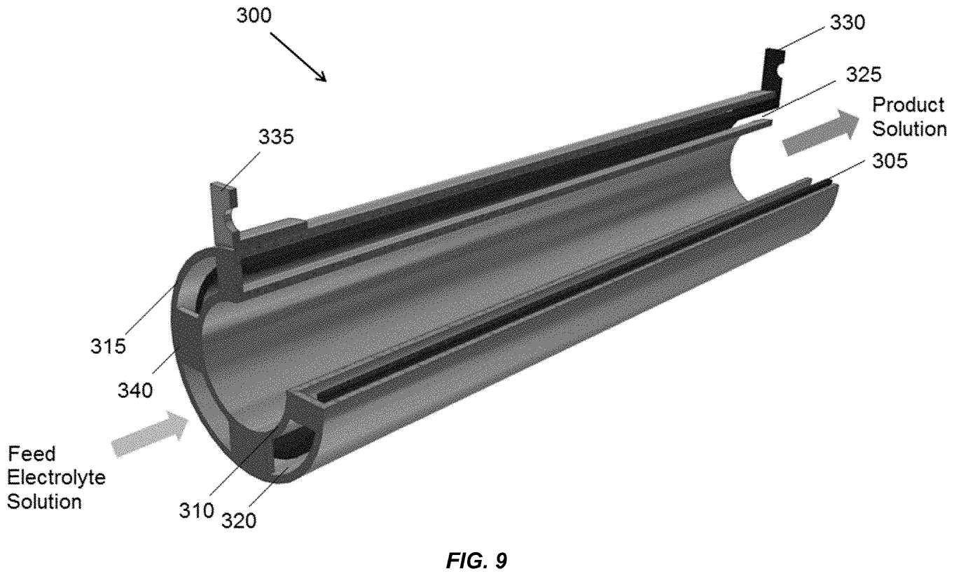

Aspects and embodiments disclosed herein may be applied to electrochemical cells including concentrically arranged tubular electrodes, non-limiting examples of which are illustrated in FIGS. 9-11. At least some of the concentric tube electrodes may be mono-polar or bi-polar. A first embodiment, including three concentric tubes, is illustrated in FIG. 9 indicated generally at 300. The middle tube electrode 305 is an anode having an oxidation resistant coating, for example, platinum or MMO, on both the inner and outer surface to make full use of the surface area of the middle tube electrode 305. The inner tube electrode 310 and outer tube electrode 315 have no coating, acting as an inner cathode and an outer cathode, respectively. The electrodes are mono-polar such that current passes through the electrolyte once per electrode. Each of the electrodes 305, 310, 315 may include a titanium tube. The anode electrical connection 330 is in electrical communication with the middle tube electrode 305. The cathode electrical connection 335 is in electrical communication with the inner tube electrode 310 and outer tube electrode 315. In other embodiments, the middle tube electrode 305 may be the cathode and the inner tube electrode 310 and outer tube electrode 315 may be anodes. Electrochlorination cell 300 and other electrochemical cells including concentric tube electrodes disclosed herein may be included in a non-conductive housing, for example, housing 235 illustrated in FIG. 8.

In embodiments disclosed herein including multiple anode or cathode tube electrodes, the multiple anode tube electrodes may be referred to collectively as the anode or the anode tube, and the multiple cathode tube electrodes may be referred to collectively as the cathode or the cathode tube. In embodiments including multiple anode and/or multiple cathode tube electrodes, the multiple anode tube electrodes and/or multiple cathode tube electrodes may be collectively referred to herein as an anode-cathode pair.

Electrical connection may be made between the inner tube electrode 310 and outer tube electrode 315 by one or more conductive bridges 340, which may be formed of the same material as the inner tube electrode 310 and outer tube electrode 315, for example, titanium. Electrochemical and chemical reactions occur at the surfaces of the electrodes and in the bulk solution to generate a product solution, for example, hydrogen peroxide as a source of oxidizing free radicals in a UV AOP reactor or sodium hypochlorite for quenching residual hydrogen peroxide in a treated aqueous solution exiting a UV AOP reactor.

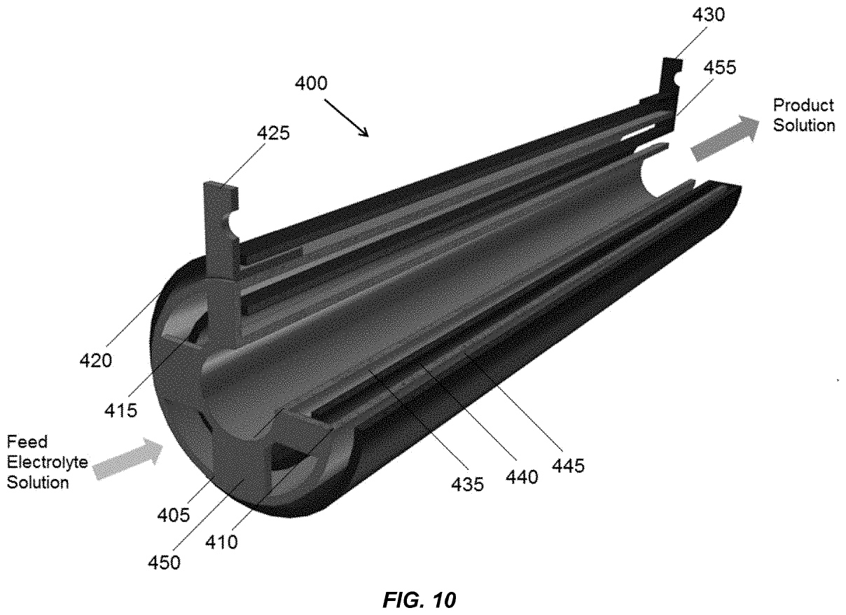

In accordance with another embodiment, a concentric tube electrochemical or electrochlorination cell includes four concentric tube electrodes. An example of a four tube electrochlorination cell is shown in FIG. 10, indicated generally at 400. The four tube electrochlorination cell 400 includes inner tube electrode 405 and intermediate tube electrode 410 that act as anodes and that may be in electrical communication with anode electrical connector 425. Inner tube electrode 405 and intermediate tube electrode 410 may also be in electrical communication with one another via one or more conductive bridges 450. Outer tube electrode 420 and intermediate tube electrode 415 act as cathodes that may be in electrical communication with cathode electrical connector 430. Outer tube electrode 420 and intermediate tube electrode 415 may also be in electrical communication with one another via one or more conductive bridges 455. Outer tube electrode 420 and intermediate tube electrode 415 are disposed on opposite sides of intermediate anode tube electrode 410. The four tube electrochlorination cell 400 works in a similar way to the three tube electrochlorination cell 300, except that a feed electrolyte solution flows through the three annular gaps 435, 440, 445 formed in the four tube electrochlorination cell 400. In another embodiment, the outer tube electrode 420 and intermediate tube electrode 415 may be anodes and the inner tube electrode 405 and intermediate tube electrode 410 may be cathodes.

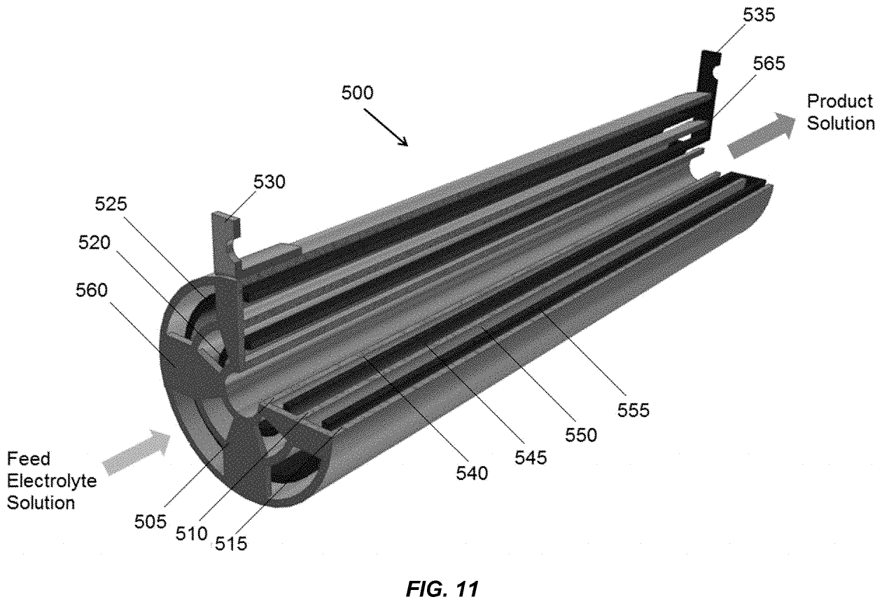

In accordance with another embodiment, a concentric tube electrochlorination cell includes five concentric tube electrodes. An example of a five tube electrochlorination cell is shown in FIG. 11, indicated generally at 500. The five tube electrochlorination cell 500 includes intermediate tube electrodes 520 and 525 that act as anodes and that may be in electrical communication with anode electrical connector 535. Intermediate tube electrodes 520, 525 may also be in electrical communication with one another via one or more conductive bridges 565. Inner tube electrode 505, center tube electrode 510, and outer tube electrode 515 act as cathodes that may be in electrical communication with cathode electrical connector 530. Inner tube electrode 505, center tube electrode 510, and outer tube electrode 515 may also be in electrical communication with one another via one or more conductive bridges 560. Intermediate tube electrodes 520, 525 are disposed on opposite sides of center anode tube electrode 510. The five tube electrochlorination cell works in a similar way to the four tube electrochlorination cell 400, except a feed electrolyte solution flows through the four annular gaps 540, 545, 550, 555 formed in the five tube electrochlorination cell. In other embodiments, the inner tube electrode 505, center tube electrode 510, and outer tube electrode 515 may be anodes and the intermediate tube electrodes 520 and 525 may be cathodes.

Electrochemical cells including spiral wound, concentric, radially arranged, and interleaved electrodes and methods of electrochemically generating compounds such as sodium hypochlorite in same are described in further detail in commonly owned PCT application PCT/US2016/018213, Publication No. WO2016133983 which is incorporated in its entirety herein by reference.

Systems disclosed herein may include an actinic radiation reactor, for example, a UV reactor, that receives one or more oxidants generated in an electrochemical cell as disclosed herein to facilitate destruction, e.g., oxidation, of one or more contaminants in water undergoing treatment in the actinic radiation reactor. The actinic radiation reactor can comprise a vessel, and a first array of tubes in the vessel. The first array of tubes can comprise a first set of parallel tubes, and a second set of parallel tubes. Each tube can comprise at least one ultraviolet lamp and each of the parallel tubes of the first set is positioned to have its longitudinal axis orthogonal relative to the longitudinal axis of the tubes of the second set.

In examples of an actinic radiation reactor utilized in systems disclosed herein, organic compounds in water undergoing treatment can be oxidized by one or more free radical species into carbon dioxide, which can be removed in one or more downstream unit operations. The actinic radiation reactor can comprise at least one free radical activation device that converts one or more precursor compounds, for example, one or more oxidants provided by an electrochlorination device, into one or more free radical scavenging species, for example, the hydroxyl radical OH. The actinic radiation reactor can comprise one or more lamps, in one or more reaction chambers, to irradiate or otherwise provide actinic radiation to the water and divide the precursor compound into the one or more free radical species.

The reactor can be divided into two chambers by one or more baffles between the chambers. The baffle can be used to provide mixing or turbulence to the reactor or prevent mixing or promote laminar, parallel flow paths through the interior of the reactor, such as in the chambers. In certain embodiments, a reactor inlet is in fluid communication with a first chamber and a reactor outlet is in fluid communication with a second chamber.

In some embodiments, at least three reactor chambers, each having at least one ultraviolet gas discharge (UV) lamp disposed to irradiate the water in the respective chambers with light of about 185 nm, 220 nm, and/or 254 nm, or ranging from about 185 nm to about 254 nm, at various power levels, are serially arranged in reactor 120. It is to be appreciated that the shorter wavelengths of 185 nm to 254 nm or 190 nm to 200 nm may be preferable in AOP processes because UV light at these wavelengths has sufficient photon energy to create free radicals from free radical precursors (e.g., H₂O₂) utilized in the process for oxidizing dissolved organic contaminants. In contrast, disinfection processes, where UV light may be utilized to kill or disable microorganisms, may operate efficiently with UV light at the 254 nm wavelength produced by low pressure lamps. Disinfection systems would not typically utilize the more expensive medium pressure or high pressure UV lamps capable of providing significant UV intensity at the shorter 185 nm or 220 nm wavelengths.

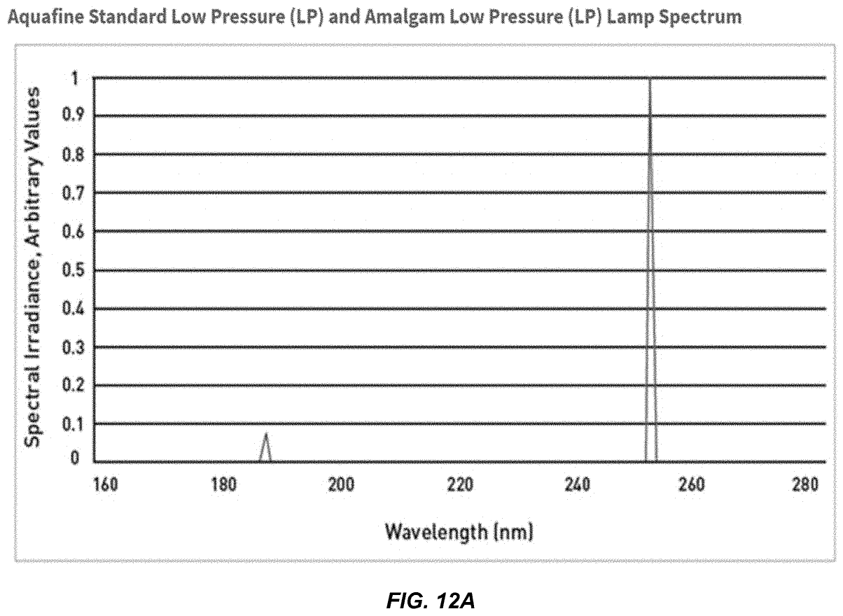

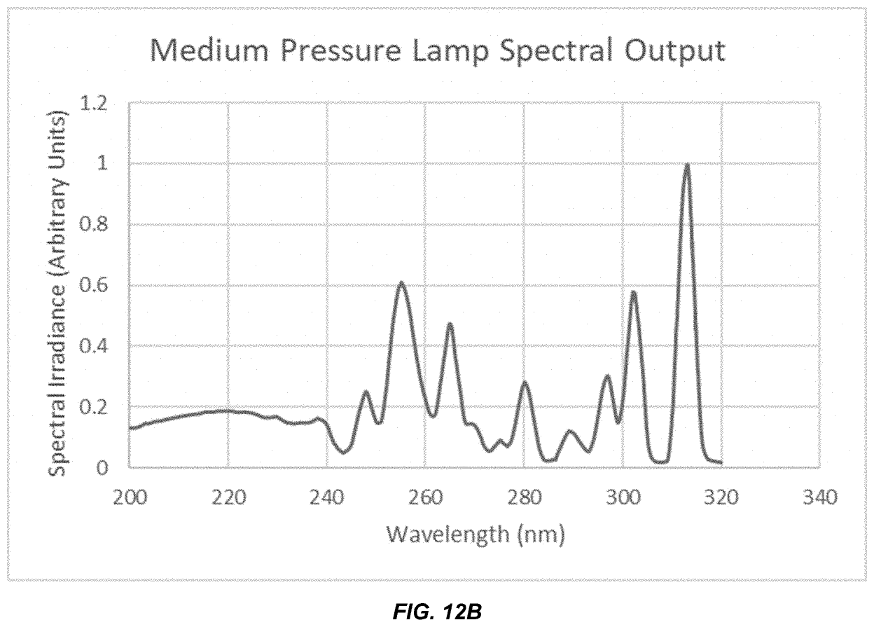

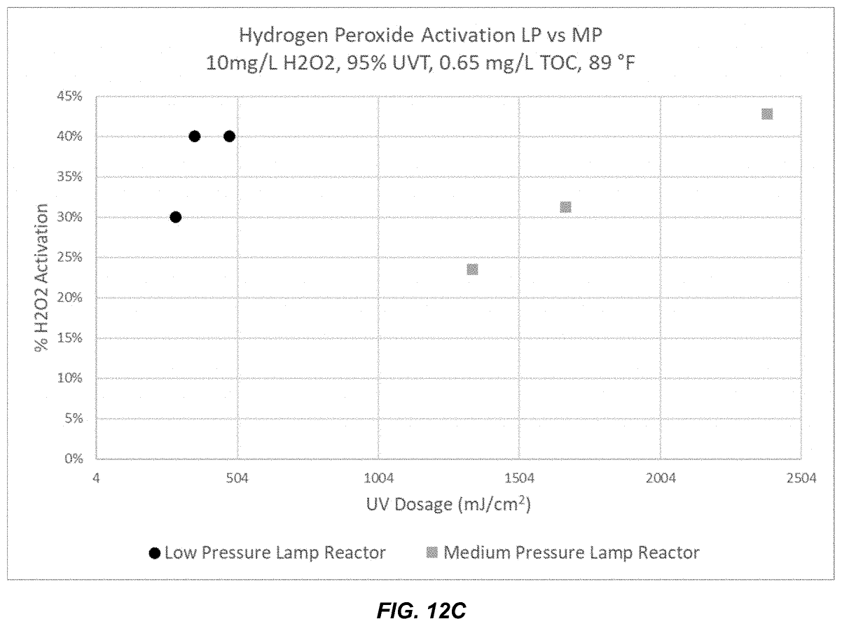

Low pressure and medium pressure UV gas discharge lamps typically emit different spectra of UV radiation. FIG. 12A illustrates the spectrum of radiation emitted by a typical low pressure UV lamp and FIG. 12B illustrates the spectrum of radiation emitted by a typical medium pressure UV lamp. The low pressure UV lamp may be more appropriate for use in AOP processes because it emits the majority of its light at wavelengths of about 185 nm and about 254 nm while the medium pressure lamp emits light over a wider range of wavelengths including longer wavelengths than the low pressure lamp. FIG. 12C, for example, illustrates that hydrogen peroxide may be activated to form hydroxyl radicals with a lower applied dosage of UV radiation (and lower power) when low pressure lamps as opposed to medium pressure lamps are utilized. In FIG. 12C “UVT” stands for ultraviolet radiation transmittance of the aqueous solution in the reactor and “TOC” stands for total organic content of the aqueous solution in the reactor. As indicated, the aqueous solution in a UV AOP reactor may not be fully transparent to UV light and may have a UV transmittance of 95% or lower. Thus, shorter fluidic path lengths between UV lamps and the aqueous solution in the reactor or turbulent flow of the aqueous solution in the reactor may result in better activation of oxidants in the aqueous solution.

It is to be appreciated that other sources of UV radiation, for example, ultraviolet light emitting diodes (LEDs) may also or alternatively be utilized in AOP processes or AOP reactors. UV LEDs are considered to be monochromatic. One may select a type of UV LED that emits radiation at a wavelength that most effectively activates and forms free radicals for a particular oxidant or oxidants in an AOP process or AOP reactor. Accordingly, UV lamps referenced in the description below may include one or both of gas-discharge lamps or LEDs.

In embodiments using UV radiation sources that emit a spectrum of radiation, for example, medium pressure gas discharge lamps, the emitted radiation may be filtered so that only a wavelength or wavelengths that most effectively activates and forms free radicals for a particular oxidant or oxidants in an AOP processes or AOP reactor is emitted into the reactor.

The one or more lamps can be positioned within the one or more actinic radiation reactors by being placed within one or more sleeves or tubes within the reactor. The tubes can hold the lamps in place and protect the lamps from the water within the reactor. The tubes can be made of any material that is not substantially degraded by the actinic radiation and the water or components of the water within the reactor, while allowing the radiation to pass through the material. The tubes can have a cross-sectional area that is circular. In certain embodiments, the tubes can be cylindrical, and the material of construction thereof can be quartz. Each of the tubes can be the same or different shape or size as one or more other tubes. The tubes can be arranged within the reactor in various configurations, for example, the sleeves may extend across a portion of or the entire length or width of the reactor. The tubes can also extend across an inner volume of the reactor.

Commercially available ultraviolet lamps and/or quartz sleeves may be obtained from Hanovia Specialty Lighting, Fairfield, N.J., Engineered Treatment Systems, LLC (ETS), Beaver Dam, Wisconsin, and Heraeus Noblelight GmbH of Hanau, Germany. The quartz material selected can be based at least in part on the particular wavelength or wavelengths that will be used in the process. The quartz material may be selected to minimize the energy requirements of the ultraviolet lamps at one or more wavelengths. The composition of the quartz can be selected to provide a desired or suitable transmittance of ultraviolet light to the water in the reactor and/or to maintain a desired or adequate level of transmissivity of ultraviolet light to the water. In certain embodiments, the transmissivity can be at least about 50% for a predetermined period of time. For example, the transmissivity can be about 80% or greater for a predetermined period of time. In certain embodiments, the transmissivity can be in a range of about 80% to 90% for about 6 months to about one year. In certain embodiments, the transmissivity can be in a range of about 80% to 90% for up to about two years.

The tubes can be sealed at each end so as to not allow the contents of the reactor from entering the sleeves or tubes. The tubes can be secured within the reactor so that they remain in place throughout the use of the reactor. In certain embodiments, the tubes are secured to the wall of the reactor. The tubes can be secured to the wall through use of a suitable mechanical technique, or other conventional techniques for securing objects to one another. The materials used in the securing of the tubes is preferably inert and will not interfere with the operation of the reactor or negatively impact the purity of the water, or release contaminants into the water.

The lamps can be arranged within the reactor such that they are parallel to each other. The lamps can also be arranged within the reactor at various angles to one another. For example, in certain embodiments, the lamps can be arranged to illuminate paths or coverage regions that form an angle of approximately 90 degrees such that they are approximately orthogonal or perpendicular to one another. The lamps can be arranged in this fashion, such that they form an approximately 90 degree angle on a vertical axis or a horizontal axis, or any axis therebetween.

In certain embodiments, the reactor can comprise an array of tubes in the reactor or vessel comprising a first set of parallel tubes and a second set of parallel tubes. Each tube may comprise at least one ultraviolet lamp and each of the parallel tubes of the first set can be arranged to be at a desired angle relative to the second set of parallel tubes. The angle may be approximately 90 degrees in certain embodiments. The tubes of any one or both of the first array and the second array may extend across an inner volume of the reactor. The tubes of the first set and the second set can be arranged at approximately the same elevation within the reactor.

Further configurations can involve tubes and/or lamps that are disposed to provide a uniform level of intensity at respective occupied or coverage regions in the reactor. Further configurations can involve equispacially arranged tubes with one or more lamps therein.

The reactor may contain one or more arrays of tubes arranged within the reactor or vessel. A second array of tubes can comprise a third set of parallel tubes, and a fourth set of parallel tubes orthogonal to the third set of parallel tubes, each tube comprising at least one ultraviolet lamp. The fourth set of parallel tubes can also be orthogonal to at least one of the second set of parallel tubes and the first set of parallel tubes.

In certain embodiments, each array within the reactor or vessel can be positioned a predetermined distance or elevation from another array within the reactor. The predetermined distance between a set of two arrays can be the same or different.

The reactor can be sized based on the number of ultraviolet lamps required to scavenge, degrade, or otherwise convert at least one of the impurities, typically the organic carbon-based impurities into an inert, ionized, or otherwise removable compound, one or more compounds that may be removed from the water, or at least to one that can be more readily removed relative to the at least one impurity. The number of lamps required can be based at least in part on lamp performance characteristics including the lamp intensity and spectrum wavelengths of the ultraviolet light emitted by the lamps. The number of lamps required can be based at least in part on at least one of the expected TOC concentration or amount in the inlet water stream and the amount of oxidant added to the feed stream or reactor.

Sets of serially arranged reactors can be arranged in parallel. For example, a first set of reactors in series may be placed in parallel with a second set of reactors in series, with each set having three reactors, for a total of six reactors. Any one or more of the reactors in each set may be in service at any time. In certain embodiments, all reactors may be in service, while in other embodiments, only one set of reactors is in service.

Commercially available sources of actinic radiation systems as components of free radical scavenging systems include those from, for example, Quantrol, Naperville, Illinois, as the AQUAFINE® UV system, and from Aquionics Incorporated, Erlanger, Ky.

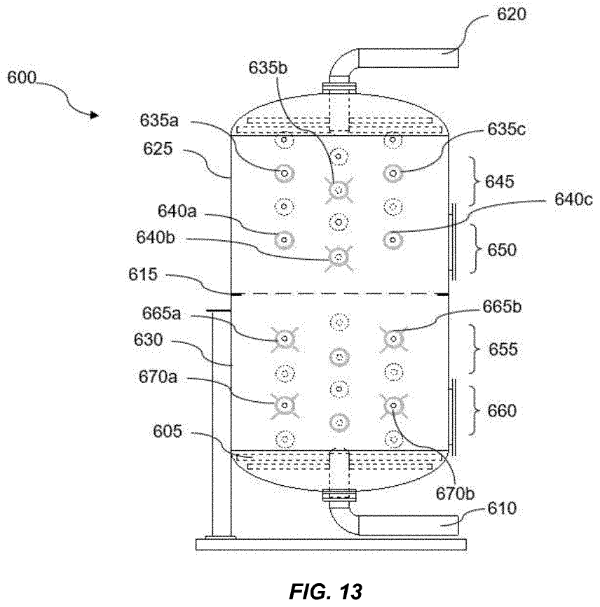

One non-limiting example of an actinic radiation reactor vessel that may be utilized in aspects and embodiments disclosed herein is illustrated in FIG. 13, generally at 600. Reactor vessel 600 typically comprises inlet 610, outlet 620, and baffle 615 which divides reactor vessel 600 into upper chamber 625 and lower chamber 630. Reactor vessel 600 can also comprise manifold 605 which can be configured to distribute water introduced through inlet 610 throughout the vessel. In certain embodiments, manifold 605 can be configured to evenly distribute water throughout the vessel. For example, manifold 605 can be configured to evenly distribute water throughout the vessel such that the reactor operates as a plug flow reactor.

In some embodiments, the reactor vessel may comprise more than one baffle 615 to divide the reactor vessel into more than two chambers. Baffle 615 can be used to provide mixing or turbulence to the reactor. In certain embodiments, as shown in FIG. 13, the reactor inlet 610 is in fluid communication with the lower chamber 630 and the reactor outlet 620 is in fluid communication with the upper chamber 625.

In some embodiments, at least three reactor chambers, each having at least one ultraviolet (UV) lamp disposed to irradiate the water in the respective chambers with light of about or ranging from about 185 nm to about 254 nm, about 185 nm to about 254 nm, about 220 nm, and/or about 254 nm at a desired or at various power levels, are serially arranged in reactor 120.

The reactor vessel can also comprise a plurality of ultraviolet lamps positioned within tubes, for example, tubes 635a-c and 640a-c. In one embodiment, as shown in FIG. 13, reactor vessel 600 comprises a first set of parallel tubes, tubes 635a-c and a second set of parallel tubes (not shown). Each set of parallel tubes of the first set is approximately orthogonal to the second set to form first array 645. Tubes 635a-c and the second set of parallel tubes are at approximately the same elevation in reactor vessel 600, relative to one another.

Further, the reactor vessel can comprise a third set of parallel tubes and a fourth set of parallel tubes. Each set of parallel tubes of the first set is approximately orthogonal to the second set to form, for example, second array 650. As exemplarily illustrated, tubes 640a-c and the second set of parallel tubes are at approximately the same elevation in reactor vessel 600, relative to one another. As shown in FIG. 13, first array 645 can be positioned at a predetermined distance from second array 650. Vessel 600 can additionally comprise third array 655 and fourth array 660, each optionally having similar configurations as first array 640 and second array 645.

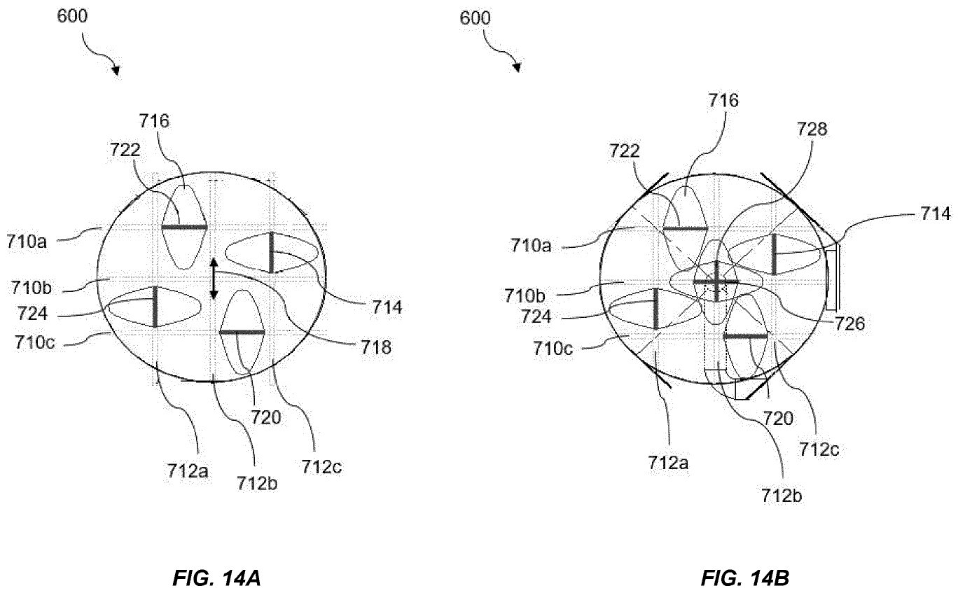

In another embodiment, a first tube 635b can be arranged orthogonal to a second tube 640b to form a first array. Additionally, a set of tubes, tube 665a and tube 665b can be arranged orthogonal to another set of tubes, tube 670a and tube 670b to form a second array. The position of the lamps of the second array are shown in FIG. 14A, including lamps 714, 720, 722, and 724. The positions of the lamps in the first array and the second array are shown in FIG. 14B, including lamps 726 and 728 of the first array and lamps 714, 720, 722, and 724 of the second array.

The lamps can generate a pattern, depending on various properties of the lamp, including the dimensions, intensity, and power delivered to the lamp. The light pattern generated by the lamp is the general volume of space to which that the lamp emits light. In certain embodiments the light pattern or illumination volume is defined as the area or volume of space that the lamp can irradiate or otherwise provide actinic radiation to and allow for division or conversion of the precursor compound into the one or more free radical species.

As shown in FIGS. 14A and 14B, which shows exemplarily cross-sectional views of reactor 600 in which a first set of tubes 710a-c are arranged parallel to one another, and a second set of tubes 712a-c are arranged parallel to one another. As shown, first set of tubes 710a-c is arranged orthogonal relative to second set of tubes 712a-c. Lamps, such as lamps 714, are dispersed within tubes 710a-c and 712a-c, and when illuminated, can generate light pattern 716.

One or more ultraviolet lamps, or a set of lamps, can be characterized as projecting actinic radiation parallel to an illumination vector. The illumination vector can be defined as a direction in which one or more lamps emits actinic radiation. In an exemplarily embodiment, as shown in FIG. 14A, a first set of lamps, including lamp 720 and 722, is disposed to project actinic radiation parallel to illumination vector 718.

A first set of ultraviolet lamps each of which is disposed to project actinic radiation parallel to a first illumination vector can be energized. A second set of ultraviolet lamps each of which is disposed to project actinic radiation parallel to a second illumination vector can also be energized. At least one of the direction of the illumination and the intensity of at least one of the first set of ultraviolet lamps and second set of ultraviolet lamps can be adjusted. Each set of ultraviolet lamps can comprise one or more ultraviolet lamps.

The number of lamps utilized or energized, the power supplied to one or more of the lamps, and the configuration of the lamps in use can be selected based on the particular operating conditions or requirements of the system. For example, the number of lamps utilized for a particular process can be selected and controlled based on characteristics or measured or calculated parameters of the system. For example, measured parameters of the inlet water or treated water can include any one or more of TOC concentration, pH, oxidant (e.g., H₂O₂) concentration, conductivity, oxidation-reduction potential, temperature, or flow rate. The number of energized lamps can also be selected and controlled based on the concentration or amount of oxidant, e.g., hydrogen peroxide added to the system or in treated aqueous solution exiting the reactor vessel. For example, 12 lamps in a particular configuration can be used if the flow rate of the aqueous solution to be treated is at or below a certain threshold value, for example, a nominal or design flow rate, such as 1300 gpm, while more lamps can be used if the flow rate of the aqueous solution to be treated rises above the threshold value. For example, if the flow rate increases from 1300 gpm to a selected higher threshold value, additional lamps can be energized. For example, 24 lamps may be used if the flow rate of the aqueous solution to be treated reaches 1900 gpm. Thus, the flow rate of the aqueous solution can be partially determinative of which lamps and/or the number of energized lamps in each reactor.

In certain embodiments, the ultraviolet lamps can be operated at one or more illumination intensity levels. For example, one or more lamps can be used that can be adjusted to operate at a plurality of illumination modes, such as at any of dim, rated, and boost mode, for example, a low, medium, or high mode. The illumination intensity of one or more lamps can be adjusted and controlled based on characteristics or measured or calculated parameters of the system, such as measured parameters of the inlet aqueous solution or treated aqueous solution, including TOC concentration, oxidation-reduction potential, pH, oxidant (e.g., H₂O₂) concentration, temperature, and/or flow rate. The illumination intensity of one or more lamps can also be adjusted and controlled based on the concentration or amount of hydrogen peroxide added to the system or residual hydrogen peroxide present in treated aqueous solution exiting the actinic radiation reactor. For example, the one or more lamps can be used in a dim mode up to a predetermined threshold value of a measured parameter of the system, such as a first TOC concentration. The one or more lamps can be adjusted to rated mode if the measured or calculated TOC concentration reaches or is above a second TOC concentration, which may be above the threshold value. The one or more lamps can further be adjusted to a boost mode if the measured or calculated TOC concentration reaches or is above a second threshold value.

Actinic radiation reactors that may be utilized in systems disclosed herein are described in further detail in commonly owned PCT application No. PCT/US2016/030708, publication No. WO2016/179241 which is incorporated in its entirety herein by reference.

Aspects and embodiments disclosed herein provide a method for a water treatment comprising the following steps: (a) adding a peroxide species, for example, hydrogen peroxide to water to be treated to be dissolved in the water to be treated, (b) measuring a demand of the peroxide species dissolved in the water to be treated (peroxide species demand) while the peroxide species dissolved in the water to be treated partly reacts with organic water constituents within the water to be treated, and (c) applying an AOP to the water to be treated while controlling the AOP by using the measured demand of the peroxide species dissolved in the water to be treated.

In a further embodiment, treated aqueous solution may be removed from a reactor in which the AOP is performed. Residual oxidant (e.g., hydrogen peroxide) in the treated aqueous solution may be quenched by addition of a quenching species (e.g., NaOCl) to the treated aqueous solution or by contacting the treated aqueous solution with activated carbon, for example, by passing the treated aqueous solution though a column of granular activated carbon (GAC). The amount, concentration, or flow rate of the quenching species added to the treated aqueous solution may be controlled based on a measured or expected concentration of the residual oxidant in the treated aqueous solution.

In a further embodiment, while controlling the AOP formation of the hydroxyl radicals is regulated, for example, by adjusting the addition of the peroxide species and/or by adjusting an addition of an alternative oxidant.

In a further embodiment, the AOP is a traditional, chemical AOP, an ultraviolet driven AOP, a peroxide species AOP, or an ultraviolet driven peroxide species AOP (UV/peroxide species AOP).

In a further embodiment, the AOP is an UV/peroxide species AOP. Controlling the UV/peroxide species AOP formation of the hydroxyl radicals is regulated by regulating an UV energy irradiating the water to be treated and/or by regulating the addition of the peroxide species.

In a further embodiment, the AOP is an UV AOP. Controlling the UV AOP formation of the hydroxyl radicals is regulated by regulating an intensity of UV energy irradiating the water to be treated and/or by regulating the addition of an alternative oxidant in a main flow of the water to be treated, while adding the peroxide species and/or measuring the demand of the peroxide species in a by-pass flow of the water to be treated.

On-site reaction product generation poses major advantages over bulk chemical dosing, both in terms of cost and overall process complexity, for UV AOP applications. Two major accelerants generally used for UV AOP include hydrogen peroxide and bulk hypochlorite.

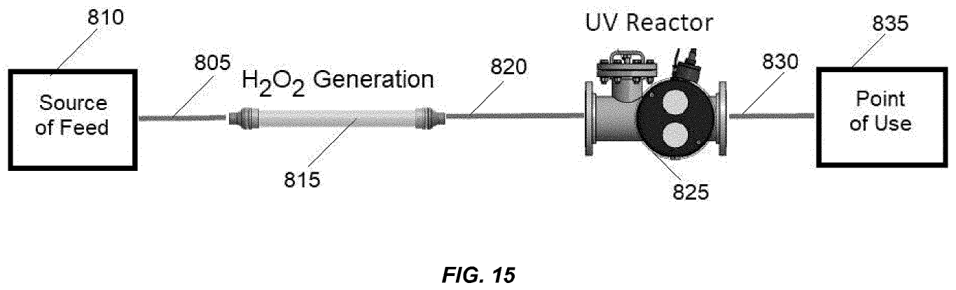

An embodiment of an inline system to generate hydrogen peroxide via CTE cell for UV AOP processes is illustrated in FIG. 15. As illustrated an electrolyte, for example, water to be treated 805 is obtained from a source of feed 810 and treated in an electrochemical cell 815, for example, but not limited to a CTE electrochemical cell, which converts oxygen present in the electrolyte into hydrogen peroxide and outputs a hydrogen peroxide-containing aqueous solution 820. The aqueous solution 820 is directed through a conduit from an outlet of the electrochemical cell 815 into an inlet of an UV AOP reactor 825. Contaminants in the aqueous solution 820 are oxidized and destroyed by exposure to UV radiation in the UV AOP reactor 825. The UV AOP reactor 825 outputs treated aqueous solution or product water 830 which is directed to a point of use 835. The treated aqueous solution 830 may meet or exceed a desired purity. As the term is used herein, purity of the treated aqueous solution or product water exiting the actinic radiation reactor refers to a concentration of one or more contaminants in the treated aqueous solution or product water. In some embodiments, the point of use 835 may be the source of feed 810, for example, when the system is used to treat water from a swimming pool, boiler, or other source of water and returns the treated water to the same source. The point of use 835 may include a shipboard system, a drilling platform system, an aquatics system (for example, a swimming pool or a fountain), a drinking water system, or a downhole of an oil drilling system. The point of use 835 may include a cooling water system of a ship or sea-based platform or a ballast tank of a ship.

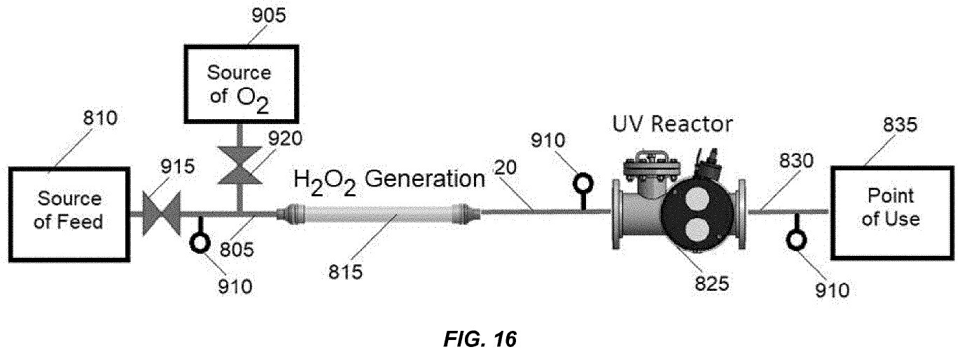

FIG. 16 depicts a system similar to that of FIG. 15, with the inclusion of an additional stage for oxygen addition. A source 905 of oxygen, for example, gaseous oxygen, air, or oxygenated water may deliver oxygen to the electrolyte/water to be treated 805 prior to introduction into the electrochemical cell 815. The source of oxygen 905 may alternatively deliver the oxygen directly into the source of feed 810. By increasing the concentration of oxygen in solution, it is possible to both reduce the energy required by the electrochemical cell 815 and increase the output of hydrogen peroxide for delivery to the downstream UV AOP reactor 825.

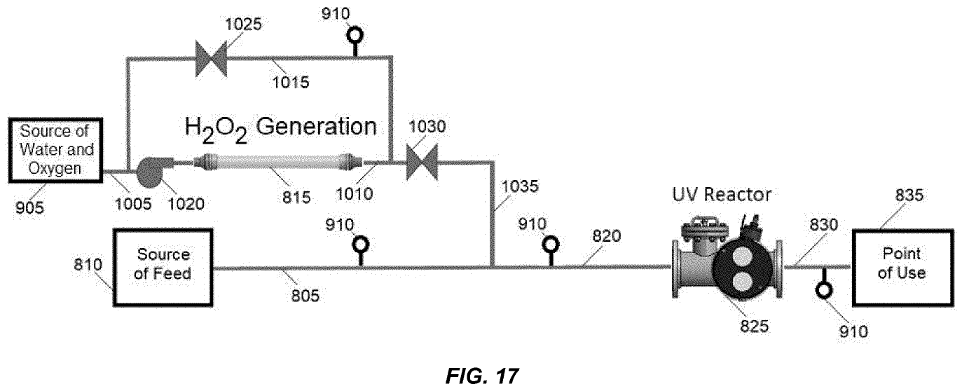

One or more sensors 910 may measure one or more parameters, for example, temperature, flow rate, contaminant concentration, pH, oxidation-reduction potential (ORP), total organic carbon (TOC), dissolved oxygen and/or hydrogen concentration, hydrogen peroxide concentration, purity, etc. of any of the electrolyte/water to be treated 805, aqueous solution 820, and/or treated aqueous solution 830. A controller of the system, described further below, may receive readings from the one or more sensors 910 and adjust one or more operating parameters of the system to obtain a desired level of a parameter or parameters read by the one or more sensors 910. The operating parameters of the system may include, for example, power (current or voltage or both) applied to the electrochemical cell 815, intensity of UV light produced in the UV AOP reactor, dosage of UV radiation applied to aqueous solution in the UV AOP reactor, flow rate of the electrolyte/water to be treated 805 using a valve 915, rate or amount of addition of the oxygen to the electrolyte/water to be treated 805 using another valve 920, or any other operating parameter of the system. Such sensors and controller(s) may also be present in the system of FIG. 15 and that of FIGS. 17-19 described below.

FIG. 17 depicts a feed and bleed system for the generation of hydrogen peroxide. The electrochemical cell 815 in this system could be of the CTE or parallel plate electrode (PPE) type. Oxygenated water 1005, or other solution including oxygen, is fed to the electrochemical cell 815 from the source of water and oxygen 905. In some embodiments, additional oxygen, is added to the oxygenated water 1005, for example, by bubbling oxygen or air through the water, to increase the oxygen concentration in the source of oxygenated water 905 to a desired level. The treated solution 1010 is recirculated through recirculation loop 1015 from the outlet of the electrochemical cell 815 back to the inlet of the electrochemical cell 815 by pump 1020 with valve 1025 open and valve 1030 shut. By recirculating the treated solution 1010, the overall concentration of hydrogen peroxide can be enhanced relative to the concentration of oxygen in solution, and one may achieve a higher concentration of hydrogen peroxide in the treated solution 1010 that might be produced from a single pass of the oxygenated water 1005 through the electrochemical cell 815. When the concentration of hydrogen peroxide in the treated recirculating solution 1010, for example, as measured by one of the sensors 910, reaches a desired level, or when the recirculating solution has been recirculated for a sufficient time to generate an expected desired concentration of hydrogen peroxide, valve 1025 may be shut and valve 1030 opened to release a high concentration hydrogen peroxide solution 1035 for mixing with the electrolyte/water to be treated 805 and form the aqueous solution 820.

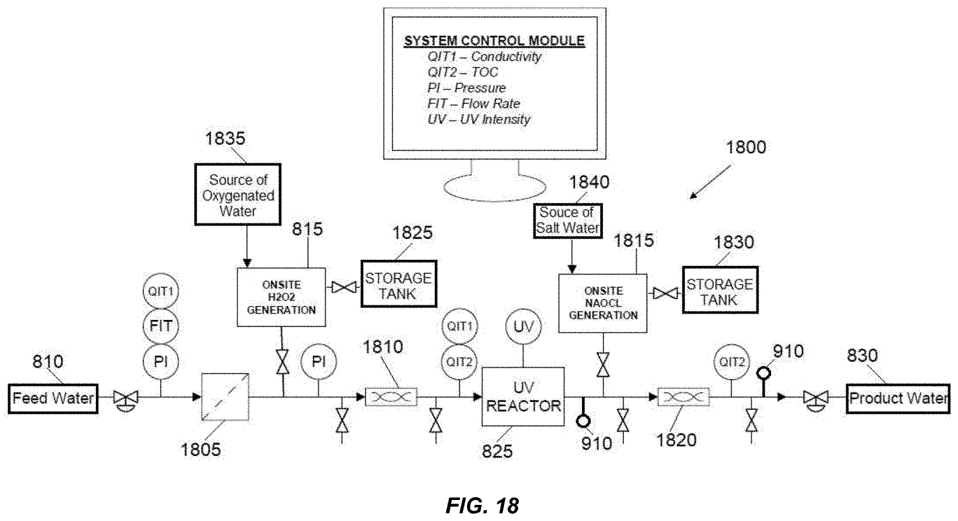

A piping and instrumentation diagram of another embodiment of a UV AOP—based treatment system is illustrated in FIG. 18. Electrolyte/water to be treated from a source of feed 810 may enter the system 1800 through a valve and pass through a conduit and through an optional pre-screen or filter 1805, for example, a membrane filter (e.g., nanofilter, ultrafilter, or reverse osmosis filter, depending on desired particle reduction) to form filtered water to be treated. Prior to entering the filter 1805, or alternatively after passing through the filer, the water to be treated or filtered water to be treated may be have one or more of its conductivity, flow rate, or pressure measured by one or more sensors QIT1, FIT, PI. Any other desired parameters of the water to be treated or filtered water to be treated, for example, TOC, dissolved concentration of one or more compounds, pH or any other parameter discussed above may also or alternatively be measured.

A metered flow of an oxidant, for example, hydrogen peroxide may be added to the filtered water to be treated from a H₂O₂ generating system 815. The H₂O₂ generating system 815 may include an on-site electrolyzer or electrochemical cell to generate the H₂O₂ as described in various embodiments above. A source of oxygenated water 1835, for example, a sub-system in which oxygen is bubbled through water to produce the oxygenated water, may supply oxygenated water to the inlet of the electrochemical cell in the H₂O₂ generating system 815 to provide sufficient oxygen to generate a desired concentration or volume of H₂O₂. The electrolyzer or electrochemical cell may be disposed in a side stream loop, for example, as illustrated in FIG. 17, or may be disposed in line with a conduit carrying the filtered water to be treated, for example, as illustrated in FIG. 15 or FIG. 16. A rate of introduction or generation of the H₂O₂ (for example, by controlling a current across an electrochemical cell in the H₂O₂ generating system 815) may be controlled based on readings from one of the sensors QIT1, FIT, PI or other sensors upstream of a point of introduction or generation of the H₂O₂ or based on readings from sensors downstream in the system as described further below. One or more parameters of the filtered water to be treated after addition of the H₂O₂, for example, pressure, flow rate, temperature, H₂O₂ concentration, etc. may be measured by one or more sensors downstream of a point of introduction or generation of the H₂O₂ and may be used as an input parameter to a control system for setting operational parameters such as flow rate of influent water to be treated or rate of introduction or generation of the H₂O₂.

Downstream of the point of introduction or generation of the H₂O₂, the water to be treated passes through a conduit into a static mixer 1810 in which the water to be treated and the added H₂O₂ are mixed to form a substantially homogenous aqueous solution. Downstream of the static mixer 1810, additional parameters of the aqueous solution, for example, conductivity or TOC level may be measured by additional sensors QIT1, QIT2. Measurements from these sensors may be used as input parameters to a control system for setting operational parameters such as flow rate of influent water to be treated or rate of introduction or generation of the H₂O₂.

Further downstream of the static mixer 1810, the aqueous solution enters a UV reactor 825. In the UV reactor 825, the aqueous solution is irradiated with UV light to active the H₂O₂ and for hydroxyl radicals which oxidize or otherwise decompose contaminants in the aqueous solution to form a UV-treated aqueous solution. A dosage of UV radiation, intensity of applied UV radiation, and/or residence time of the aqueous solution undergoing treatment in the UV reactor 825 may be controlled based on measurements form any one or more of the sensors upstream or downstream of the UV reactor 825.

The UV-treated aqueous solution exits the UV reactor 825 and, downstream of the UV reactor, a chemical agent may be added to the UV-treated aqueous solution to quench or decompose residual H₂O₂ in the UV-treated aqueous solution to form a quenched solution. The agent may be, for example sodium hypochlorite. The sodium hypochlorite may be electrochemically generated on site with an on-site NaOCl generation system 1815. The on-site NaOCl generation system 1815 may include one or more electrochemical cells as disclosed above. The one or more electrochemical cells may include flat plate anodes and/or cathodes or may include concentric tube electrodes as disclosed above. An electrolyte solution including NaCl may be provided to the NaOCl generation system 1815 from a source of salt water 1840 to provide the Na and Cl for the electrochemical generation of NaOCl. The NaOCl generation system 1815 and associated electrolyzer(s) or electrochemical cell(s) may be disposed in a side stream loop as illustrated in FIG. 18 or may be disposed in line with a conduit carrying the UV-treated aqueous solution. The rate of introduction or generation of the NaOCl may be controlled (for example, by controlling a current across an electrochemical cell in the source 1815) based on readings from one of the sensors upstream or downstream of a point of introduction or generation of the NaOCl. In some embodiments, a concentration of H₂O₂ in the UV-treated aqueous solution may be measured by one or more sensors 910, for example, an ORP sensor, upstream or downstream of the point of introduction or generation of the NaOCl and the rate of introduction or generation of the NaOCl may be set by a controller based on readings from these one or more sensors.

Downstream of the point of introduction or generation of the NaOCl the quenched treated aqueous solution may pass through a static mixture 1820 to facilitate contact between the quenching agent and H₂O₂ in the quenched treated aqueous solution and facilitate decomposition of all or substantially all of the residual H₂O₂ in the quenched treated aqueous solution to form a product water 830, which may exit the system 1800 and provided to a point of use.

Either of the H₂O₂ generating system 815 or the NaOCl generation system 1815 may have an outlet fluidically coupled to a storage tank 1825, 1830 for storage of generated H₂O₂ or NaOCl, respectively. The storage tanks may be at least partially filled during periods of low demand of the H₂O₂ or NaOCl and may provide additional H₂O₂ or NaOCl to the water undergoing treatment in the system if demand for the H₂O₂ or NaOCl should exceed a generating capacity of the H₂O₂ generating system 815 or the NaOCl generation system 1815 or when one of these systems is offline, for example, for maintenance.

It is to be appreciated that the on-site NaOCl generation system 1815 and storage tanks 1825, 1830 illustrated in FIG. 18 may also be present in any of the other systems disclosed herein, for example in the systems of any of FIG. 15-17 or 19.

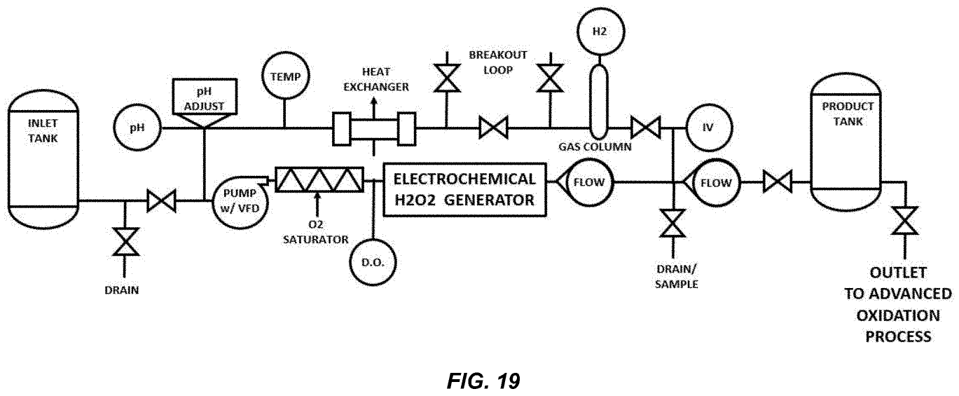

A piping and instrumentation diagram of a potential feed and bleed system is shown in FIG. 19. Such a system could be used for product generation, specifically maintaining the high operation pressures required in the recirculation loop, while delivering a low pressure product flow to the desired process stream. For design of the H₂O₂ electrochemical cell, the mass generation rate can be specified as discussed, and the final output concentration of the system tuned by the requirements of the AOP application.

Various additional pumps or valves may be included in any of the systems described above to control flow of the various aqueous solutions involved, but are not illustrated for the purpose of clarity.

In one or more embodiments, any of which may be relevant to one or more aspects, the systems and techniques disclosed herein may utilize one or more subsystems that adjusts or regulates or at least facilitates adjusting or regulating at least one operating parameter, state, or condition of at least one unit operation or component of the system or one or more characteristics or physical properties of a process stream. To facilitate such adjustment and regulatory features, one or more embodiments may utilize controllers and indicative apparatus that provide a status, state, or condition of one or more components or processes. For example, at least one sensor may be utilized to provide a representation of an intensive property or an extensive property of, for example, water from the source of feed 810 or water entering or leaving one or more electrochemical cells for generation of oxidant or quenching agent or a UV AOP reactor vessel or one or more other downstream processes. Thus, in accordance with a particularly advantageous embodiment, the systems and techniques may involve one or more sensors or other indicative apparatus, such as composition analyzers, or conductivity cells, that provide, for example, a representation of a state, condition, characteristic, or quality of the water entering or leaving any of the unit operations of the system.

Various operating parameters of the electrochlorination systems disclosed herein may be controlled or adjusted by an associated control system or controller based on various parameters measured by various sensors located in different portions of the systems. The controller may be programmed or configured to regulate introduction of oxygen or an oxygen-containing compound, for example, oxygenated water, into water to be treated to be introduced to an electrochemical cell upstream of an AOP reactor based at least on one or more of a flow rate of the water to be treated, a concentration of oxygen in the water to be treated, or a level of one or more contaminants in the water to be treated. The controller may be programmed or configured to regulate production or introduction of a quenching agent, for example, NaOCl, into water after treatment in a UV AOP reactor based at least on one or more of a flow rate of the water to be treated, a concentration of oxygen in the water to be treated, or a level of one or more contaminants in the water to be treated, or a concentration of H₂O₂ in the water after treatment in the UV AOP reactor. The controller may be programmed or configured to regulate introduction of the oxygen-containing compound into the water to be treated based at least on a concentration of oxygen or an oxygen-based compound in a peroxide-containing aqueous solution generated in the electrochemical cell. The controller may be further configured to regulate the concentration of the hydrogen peroxide generated in the electrochemical cell based at least on a concentration of one or more contaminants in the water to be treated. The controller may be programmed or configured to regulate introduction of the oxygen or oxygen-containing compound into the water to be treated based at least on one or more of temperature in the electrochemical cell or pH of the hydrogen peroxide-containing aqueous solution generated in the electrochemical cell.

The controller may be programmed or configured to regulate one or more of a current across the anode-cathode pair or a voltage applied across the anode-cathode pair of an electrochemical cell for the production of H₂O₂ based on a flow rate of the water to be treated and/or a rate of introduction of the oxygen or oxygen-containing compound into the water to be treated. The controller may be programmed or configured to regulate one or more operating parameters of the AOP reactor based on any one or more of flow rate or contaminant concentration of hydrogen peroxide-containing aqueous solution entering the AOP reactor, temperature or pH of the hydrogen peroxide-containing aqueous solution entering the AOP reactor, or hydrogen peroxide concentration of the hydrogen peroxide-containing aqueous solution entering the AOP reactor.

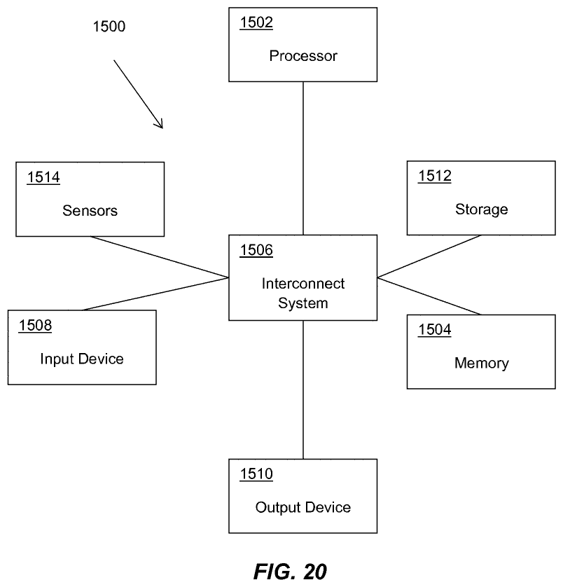

The controller used for monitoring and controlling operation of the various elements of systems disclosed herein may include a computerized control system. Various aspects of the controller may be implemented as specialized software executing in a general-purpose computer system 1500 such as that shown in FIG. 20. The computer system 1500 may include a processor 1502 connected to one or more memory devices 1504, such as a disk drive, solid state memory, or other device for storing data. Memory 1504 is typically used for storing programs and data during operation of the computer system 1500. Components of computer system 1500 may be coupled by an interconnection mechanism 1506, which may include one or more busses (e.g., between components that are integrated within a same machine) and/or a network (e.g., between components that reside on separate discrete machines). The interconnection mechanism 1506 enables communications (e.g., data, instructions) to be exchanged between system components of system 1500. Computer system 1500 also includes one or more input devices 1508, for example, a keyboard, mouse, trackball, microphone, touch screen, and one or more output devices 1510, for example, a printing device, display screen, and/or speaker.

The output devices 1510 may also comprise valves, pumps, or switches which may be utilized to introduce oxygen or an oxygen-containing compound (e.g., oxygenated water) from the source 905 into the water to be treated and/or to control the speed of pumps or the state (open or closed) of valves of systems as disclosed herein. One or more sensors 1514 may also provide input to the computer system 1500. These sensors may include, for example, sensors 910, QIT1, QIT2, FIT, or PI which may be, for example, pressure sensors, chemical concentration sensors, temperature sensors, or sensors for any other parameters of interest to the systems disclosed herein. These sensors may be located in any portion of the system where they would be useful, for example, upstream of point of use 835, upstream or downstream of electrochlorination cell 815, AOP reactor 825, point of generation or introduction of oxidizer or quenching agent into water passing through the systems disclosed herein, or in fluid communication with source of feed 810. In addition, computer system 1500 may contain one or more interfaces (not shown) that connect computer system 1500 to a communication network in addition or as an alternative to the interconnection mechanism 1506.

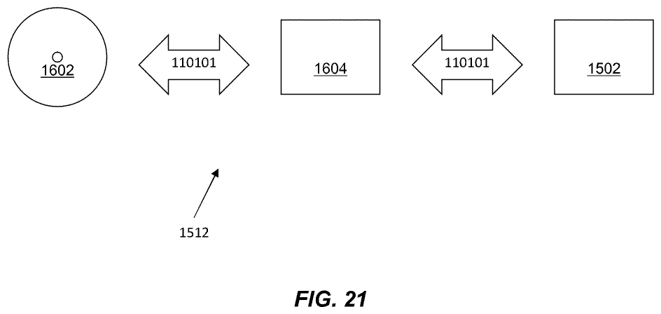

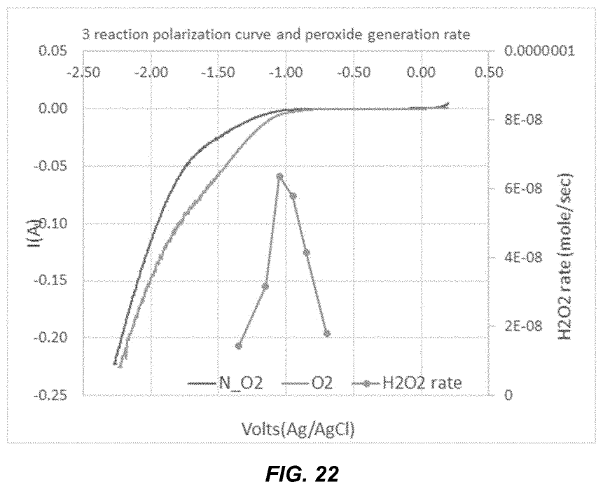

The storage system 1512, shown in greater detail in FIG. 21, typically includes a computer readable and writeable nonvolatile recording medium 1602 in which signals are stored that define a program to be executed by the processor 1502 or information to be processed by the program. The medium may include, for example, a disk or flash memory. Typically, in operation, the processor causes data to be read from the nonvolatile recording medium 1602 into another memory 1604 that allows for faster access to the information by the processor than does the medium 1602. This memory 1604 is typically a volatile, random access memory such as a dynamic random access memory (DRAM) or static memory (SRAM). It may be located in storage system 1512, as shown, or in memory system 1504. The processor 1502 generally manipulates the data within the integrated circuit memory 1604 and then copies the data to the medium 1602 after processing is completed. A variety of mechanisms are known for managing data movement between the medium 1602 and the integrated circuit memory element 1604, and aspects and embodiments disclosed herein are not limited thereto. Aspects and embodiments disclosed herein are not limited to a particular memory system 1504 or storage system 1512.

The computer system may include specially-programmed, special-purpose hardware, for example, an application-specific integrated circuit (ASIC). Aspects and embodiments disclosed herein may be implemented in software, hardware or firmware, or any combination thereof. Further, such methods, acts, systems, system elements and components thereof may be implemented as part of the computer system described above or as an independent component.

Although computer system 1500 is shown by way of example as one type of computer system upon which various aspects and embodiments disclosed herein may be practiced, it should be appreciated that aspects and embodiments disclosed herein are not limited to being implemented on the computer system as shown in FIG. 20. Various aspects and embodiments disclosed herein may be practiced on one or more computers having a different architecture or components than shown in FIG. 20.

Computer system 1500 may be a general-purpose computer system that is programmable using a high-level computer programming language. Computer system 1500 may be also implemented using specially programmed, special purpose hardware. In computer system 1500, processor 1502 is typically a commercially available processor such as the well-known Pentium™ or Core™ class processors available from the Intel Corporation. Many other processors are available, including programmable logic controllers. Such a processor usually executes an operating system which may be, for example, the Windows 7, Windows 8, or Windows 10 operating system available from the Microsoft Corporation, the MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that aspects and embodiments disclosed herein are not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects and embodiments disclosed herein may be performed on a client-server system that includes components distributed among one or more server systems that perform various functions according to various aspects and embodiments disclosed herein. These components may be executable, intermediate (e.g., IL) or interpreted (e.g., Java) code which communicate over a communication network (e.g., the Internet) using a communication protocol (e.g., TCP/IP). In some embodiments one or more components of the computer system 1500 may communicate with one or more other components over a wireless network, including, for example, a cellular telephone network.

It should be appreciated that the aspects and embodiments disclosed herein are not limited to executing on any particular system or group of systems. Also, it should be appreciated that the aspects and embodiments disclosed herein are not limited to any particular distributed architecture, network, or communication protocol. Various aspects and embodiments disclosed herein are may be programmed using an object-oriented programming language, such as SmallTalk, Java, C++, Ada, or C# (C-Sharp). Other object-oriented programming languages may also be used. Alternatively, functional, scripting, and/or logical programming languages may be used, for example, ladder logic. Various aspects and embodiments disclosed herein may be implemented in a non-programmed environment (e.g., documents created in HTML, XML or other format that, when viewed in a window of a browser program, render aspects of a graphical-user interface (GUI) or perform other functions). Various aspects and embodiments disclosed herein may be implemented as programmed or non-programmed elements, or any combination thereof.

In some embodiments, an existing UV AOP system may be modified or upgraded to include elements of the electrochlorination systems disclosed herein or to operate in accordance with the systems disclosed herein. A method of retrofitting a UV AOP system cell to increase the rate of destruction of contaminants in the UV AOP system may include installing a electrochlorination cell configured to introduce an oxidizing agent into electrolyte upstream of an inlet of the UV AOP reactor and/or a quenching agent into UV-treated water downstream of the UV AOP reactor.

### EXAMPLES

### Example 1

Tests were performed to evaluate the generation of hydrogen peroxide in an electrochemical cell including an anode, cathode, and a cation exchange membrane disposed between the anode and cathode. Results of this testing are illustrated in FIG. 20. In this figure, the blue curve was generated from testing of performance of the electrochemical cell with unoxygenated water and the orange curve was generated from testing of the electrochemical cell with water through which oxygen had been bubbled at atmospheric pressure until the water was saturated with oxygen. As illustrated the rate of hydrogen peroxide generation first increased with increasing voltage and then decreased with additional increasing voltage. At lower voltages, the rate of generation of hydrogen peroxide is believed to have been limited by the concentration of oxygen in the water. At higher voltages (closer to zero) the rate of generation of hydrogen peroxide is believed to have been limited by the low current.

### Example 2

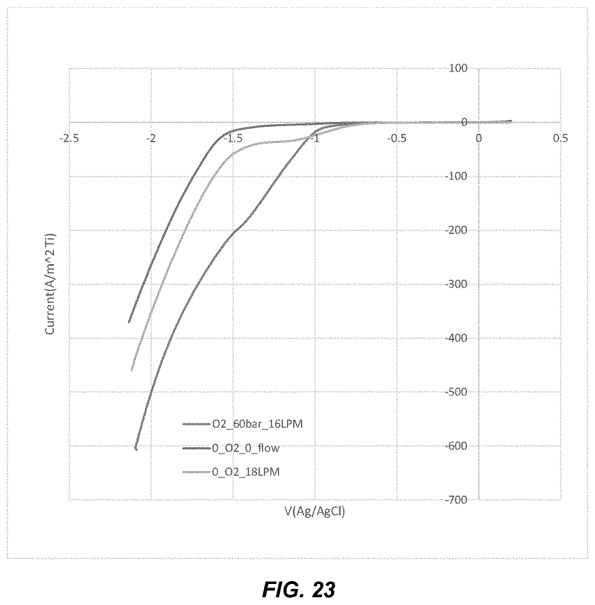

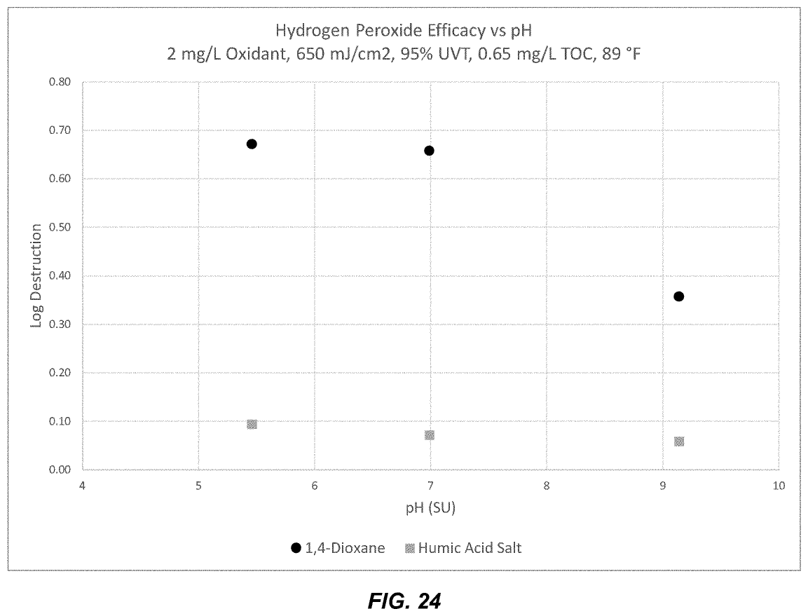

Tests were performed to characterize voltage vs. current for an electrolytic cell having flat plate electrodes formed from titanium mesh each having areas of 10 cm². In the tests water having either no added oxygen or after being exposed to oxygen at a pressure of 60 bar was flowed through the cell at different flow rates. The results are illustrated in the chart in FIG. 23. As can be seen, for each condition tested, current increased (became more negative) as the absolute value of the applied voltage increased (became more negative). The lowest increase in current vs. voltage was observed under the conditions of no added oxygen and zero flow rate (the 0_O2_0_flow curve). As the flow rate of the water with no added oxygen increased to 18 liters per minute (the 0_O2_18LPM curve) the current observed at particular voltages increased relative to the condition of no added oxygen and zero flow rate. For the oxygenated water flowed through the electrolytic cell at 16 liters per minute (the O2_60bar_16LPM curve) the current observed at particular voltages increased even further. These results show that as additional oxygen was included in the water flowed through the electrolytic cell increased, the ability of the electrolytic cell to supply current used to perform reactions between the oxygen and water increased. These results show the benefit of adding oxygen to water to be flowed through an electrolytic cell for the production of reactants such as H₂O₂.

### Example 3

Testing was performed to evaluate how concentration of hydrogen peroxide in a solution increased with time within an electrolytic cell. An electrolytic cell was formed with a cathode formed of carbon cloth and an anode formed of mixed metal oxide. The anode and cathode were placed in 80 ml of a 5 mM Na₂SO₄ isolution. Oxygen was bubbled through the solution for 30 minutes. A current of 5 mA was applied across the electrodes. After 30 minutes of application of the current the concentration of hydrogen peroxide in the solution was 12.75 ppm. After 2 hours of application of the current the hydrogen peroxide concentration increased to 29.75 ppm. These results show that electrolytic generation of hydrogen peroxide can produce higher concentrations of hydrogen peroxide in solution as the time for which current is applied increases.

### Example 4

Testing was performed to evaluate the effect of pH on contaminant (1,4-Dioxane and Humic Acid, each at a concentration of 0.65 mg/L) destruction in a UV AOP reactor. The UV dose was 650 mJ/cm², the hydrogen peroxide concentration was 2 mg/L, and the temperature was 89° F. The results of this testing are shown in FIG. 24. As can be seen from the chart in FIG. 24 the destruction rates of the contaminants increased with reduced pH, although the increase in destruction rate did not increase significantly as the pH was reduced below neutral. These results show that it may be desirable to operate a UV AOP reactor with H₂O₂ oxidant at a neutral or acidic pH to optimize contaminant destruction.

### Example 5

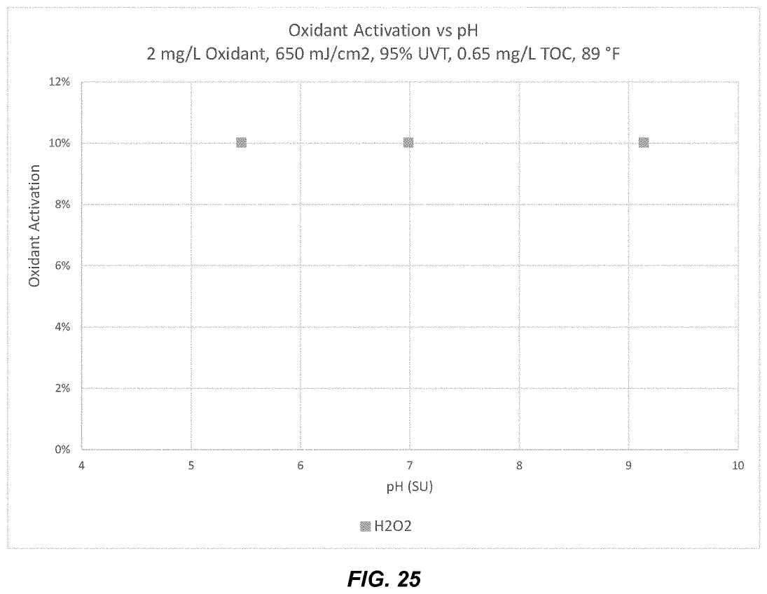

Testing was performed to evaluate the effect of pH on activation of H₂O₂ in a UV AOP reactor. The UV dose was 650 mJ/cm², the TOC of the solution in the reactor was 0.65 mg/L, the hydrogen peroxide concentration was 2 mg/L, and the temperature was 89° F. The results of this testing is presented in FIG. 25. As can be observed from the chart in FIG. 25, the activation rate (percent activated) of the H₂O₂ was about 10% under the test conditions, with pH having no detectable effect. These results indicate that a change in activation rate of the H₂O₂ was unlikely to be the cause of the increased contaminant destruction rate at lower pH levels observed in Example 4 above.

### Example 6

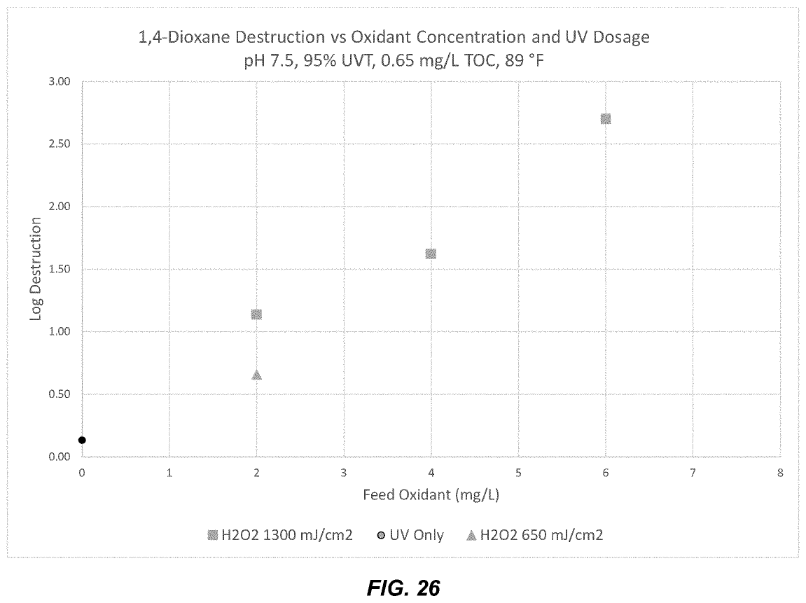

Testing was performed to evaluate the effect of H₂O₂ concentration and UV dosage upon the activation rate of H₂O₂ in a UV AOP reactor. The UV dose was either 1300 mJ/cm² or 650 mJ/cm², the TOC of the solution in the reactor was 0.65 mg/L, and the temperature was 89° F. The results of this testing is presented in FIG. 2. As can be observed from the chart in FIG. 26, the activation rate of the H₂O₂ increased from about 10% to about 30% as the UV dose was increased from 650 mJ/cm² to 1300 mJ/cm² while H₂O₂ concentration had no observable effect on oxidant activation. These results show that the activation rate of the H₂O₂ increases non-linearly with increase in UV dosage and that increasing the UV dosage by a certain percent would have a greater effect on the amount of available hydroxyl radicals than if the concentration of H₂O₂ in solution provided to the UV AOP reactor was increased by the same percent.

### Example 7

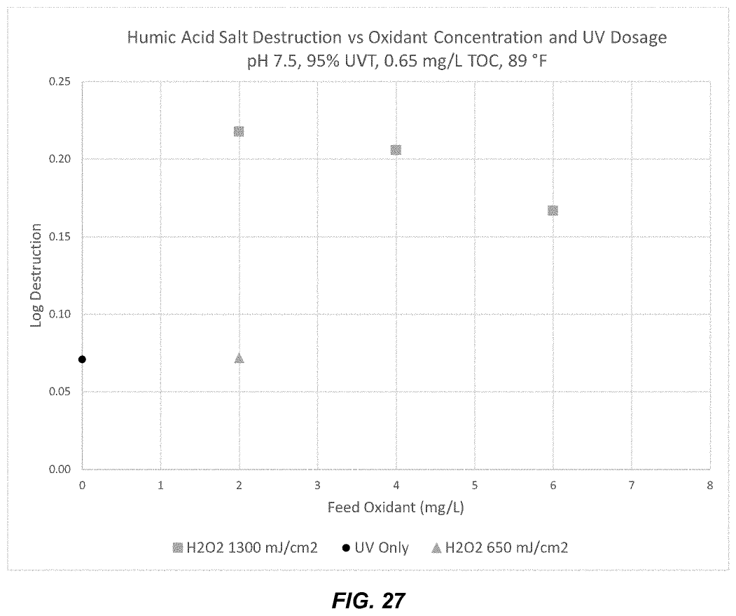

Testing was performed to evaluate the amount of destruction of 1,4-Dioxane and humic acid in a UV AOP reactor at different UV dosages and H₂O₂ concentrations. The results for the testing with 1,4-Dioxane are shown in FIG. 26 and the results for testing with humic acid are shown in FIG. 27. These data show that increasing UV dosage has a significant effect on increasing the destruction of both contaminants. The destruction of 1,4-Dioxane increased with H₂O₂ concentration, while, unexpectedly, the destruction of humic acid decreased with increasing H₂O₂ concentration. These results show that the destruction of different contaminants may be optimized at different concentrations of hydrogen peroxide. The results also confirmed that the presence of the H₂O₂ increased the rate of contaminant concentration as opposed to the UV AOP reactor operating without H₂O₂ in solution.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure, and are intended to be within the scope of the invention. Accordingly, the foregoing description and drawings are by way of example only.

1. A water treatment system comprising:
an actinic radiation reactor;
an electrochemical cell configured to produce hydrogen peroxide and having an outlet in fluid communication between a source of electrolyte and the actinic radiation reactor; and
a source of oxygen in communication with an inlet of the electrochemical cell.

2. The system of claim 1, further comprising:
a first conduit fluidically coupling the source of electrolyte to the inlet of the electrochemical cell; and
a second conduit fluidically coupling the outlet of the electrochemical cell to an inlet of the actinic radiation reactor.

3. The system of claim 1, wherein the outlet of the electrochemical cell is fluidically coupled to a point of introduction in a conduit fluidically coupling the source of electrolyte to the inlet of the electrochemical cell.

4. The system of claim 1, wherein the actinic radiation reactor is an ultraviolet advanced oxidation process reactor.

5. The system of claim 1, wherein the electrolyte comprises water.

6. The system of claim 1, further comprising a storage tank coupled to the outlet of the electrochemical cell.

7. The system of claim 1, further comprising:
a conduit fluidically coupled to an outlet of the actinic radiation reactor; and
a second electrochemical cell having an outlet in fluid communication with the conduit downstream of the outlet of the actinic radiation reactor, the second electrochemical cell configured to produce a chemical agent that quenches hydrogen peroxide present in a treated aqueous solution in the conduit.

8. The system of claim 7, further comprising a storage tank coupled to the outlet of the second electrochemical cell.

9. The system of claim 7, wherein the chemical agent includes sodium hypochlorite.

10. The system of claim 7, wherein the conduit fluidically couples the outlet of the actinic radiation reactor to an inlet of the second electrochemical cell.

11. The system of claim 7, wherein the outlet of the second electrochemical cell is fluidically coupled to a point of introduction in the conduit downstream of the outlet of the actinic radiation reactor.

12. The system of claim 7, further comprising a sensor configured to measure a concentration of one or more contaminants in an aqueous solution, the sensor positioned one of upstream of the actinic radiation reactor or downstream of the actinic radiation reactor.

13. The system of claim 12, further comprising a controller in communication with the sensor and configured to adjust one or more operating parameters of the system responsive to a measured concentration of the one or more contaminants.

14. The system of claim 13, wherein the one or more operating parameters including one of power applied to the electrochemical cell, power applied to the second electrochemical cell, power applied to the actinic radiation reactor, and flow rate of electrolyte or aqueous solution through one of the electrochemical cell, the second electrochemical cell, or the actinic radiation reactor.

15. The system of claim 13, wherein the source of oxygen is configured to introduce the oxygen into the electrolyte upstream of the electrochemical cell.

16. The system of claim 15, wherein the controller is further configured to regulate a rate of introduction of the oxygen into the electrolyte responsive to the measured concentration of the one or more contaminants.

17. The system of claim 6, further comprising a controller configured to adjust a flow rate of hydrogen peroxide from the storage tank into the actinic radiation reactor based on one or more measured characteristics of electrolyte from the source of electrolyte or one or more measured characteristics of a treated aqueous solution generated in the actinic radiation reactor.

18. The system of claim 8, further comprising a controller configured to adjust a flow rate of sodium hypochlorite from the storage tank into the conduit downstream of the outlet of the actinic radiation reactor based on one or more measured characteristics of electrolyte from the source of electrolyte or one or more measured characteristics of a treated aqueous solution generated in the actinic radiation reactor.

19. The system of claim 7, further comprising a sensor configured to measure a concentration of hydrogen peroxide in treated aqueous solution downstream of the actinic radiation reactor.

20. The system of claim 19, further comprising a controller in communication with the sensor and configured to adjust one or more operating parameters of the second electrochemical cell based on a measured concentration of the hydrogen peroxide.

21. The system of claim 20, wherein the one or more operating parameters of the second electrochemical cell include one or more of power applied to the second electrochemical cell, flow rate of electrolyte into the second electrochemical cell, flow rate of sodium hypochlorite out of the second electrochemical cell, or concentration of sodium hypochlorite produced in the second electrochemical cell.

22-67. (canceled)
